(19) United States
(12) Patent Application Publication
(10) Pub. No.: US 2025/0387974 A1
(43) Pub. Date: Dec. 25, 2025

(54) PLANAR AND NON-PLANAR ANISOTROPIC TOOLPATH GENERATION FOR PRODUCTION OF PRINTED ARTICLES

(71) Applicant: NOVINEER, INC., Daytona Beach, FL (US)

(72) Inventors: Ali Tamijani, Daytona Beach, FL (US); Zhichao Wang, Daytona Beach, FL (US)

(21) Appl. No.: 19/223,681

(22) Filed: May 30, 2025

Related U.S. Application Data
(60) Provisional application No. 63/653,544, filed on May 30, 2024.

(51) Int. Cl. B29C 64/393; B29C 64/118; B33Y 30/00; B33Y 50/02

(52) U.S. Cl. CPC B29C 64/393; B33Y 50/02; B29C 64/118; B33Y 30/00

(57) ABSTRACT

Methods and systems that can be used to provide reinforced anisotropic printed articles are described. The methods and systems can generate generated toolpaths to provide reinforced regions, to reduce material usage or to reduce print head repositioning events as desired during additive manufacturing processes. Planar and non-planar printed articles can be produced using the method and systems.

### PRIORITY APPLICATION

This application is related to, and claims priority to and the benefit of, U.S. Provisional Application No. 63/653,544 filed on May 30, 2024, the entire disclosure of which is hereby incorporated herein by reference for all purposes.

### TECHNOLOGICAL FIELD

This application is related to systems and methods that can generate and/or use anisotropic toolpaths to produce printed articles. Planar and non-planar toolpaths can be generated and used to print articles that include reinforced regions or which are produced using less material and/or fewer repositioning events during printing.

### BACKGROUND

Various manufacturing processes are used to produce articles. One methodology involves the use of printing processes which can be single or multidimensional. Printing processes can suffer from imperfections particularly where high stress loads are intended to be applied to the resulting printed articles. Further, toolpaths which are used in the printing processes often require the use of excess material and overlapping paths which can increase cost and time in producing the articles. In many instances to print complex structures, the printing tool must be repositioned numerous times, which can result in extended print times and gaps or voids in the printed article.

### SUMMARY

Certain aspects, embodiments, configurations and features are described in more detail below of methods and systems that can generate toolpaths for use in printing of filament to produce a printed article.

In an aspect, a method for generating reinforcement-aware toolpaths in an additive manufacturing process comprises using a geometric model including mechanical boundary conditions and anisotropic material properties. For example, the method comprises decomposing a received geometric model into a group of individual layers, e.g., layers with a common structure or similarly arranged reinforcement areas. In some embodiments, for at least one layer in the decomposed group of individual layers: generating reinforcement guidelines using a geometry skeleton or simulation-driven design optimization applied to the at least one layer to increase at least one mechanical property of a printed article, and applying buffering logic to the generated reinforcement guidelines to generate buffered reinforcement zones, wherein the generated buffered reinforcement zones correspond to the reinforcement-aware toolpaths used to print the at least one layer using the additive manufacturing process.

In certain embodiments, the geometric model (or some portion thereof) is provided by a user. In other embodiments, the geometric model is generated using structural simulations. In certain configurations, the geometric model is decomposed into a plurality of islands, and wherein at least two of the plurality of islands are connected by the geometry skeleton. In some configurations, the buffering logic comprises Minkowski-based expansion logic applied to the at least two islands and connected geometry skeleton to generate the buffered reinforcement zones. In other configurations, the buffering logic comprises polygonal offsetting. In some embodiments, the buffering logic comprises Boolean union or Boolean intersection.

In certain embodiments, the reinforcement-aware toolpaths are generated across at least two separate layers of the printed article to be deposited, wherein each of the layers is assigned a single load-boundary pair. In other embodiments, the reinforcement-aware toolpaths are generated by enlarging the reinforced guidelines in a first layer using the buffering logic so the reinforcement-aware toolpath prints additional material in the first layer to increase mechanical strength in the first layer.

In some embodiments, for each group of individual layers, the method comprises generating the reinforcement guidelines using the geometry skeleton or simulation-driven design optimization applied to each of the decomposed group of individual layers to increase at least one mechanical property of the printed article, and applying buffering logic to the generated reinforcement guidelines in each of the decomposed groups to generate buffered reinforcement zones for each of the decomposed groups corresponding to the reinforcement-aware toolpaths used to print that decomposed group, and wherein the method comprises exporting the corresponding reinforcement-aware toolpaths for each group to a printer to print the printed article.

In another aspect, an additive manufacturing system configured to print an article using a generated reinforcement-aware toolpath is described. For example, the additive manufacturing system comprises a processor that is programmed to decompose a received geometric model into a group of individual layers, and, for at least one layer of the decomposed group of individual layers, the processor is programmed to generate reinforcement guidelines using a geometry skeleton or simulation-driven design optimization applied to the at least one layer to increase at least one mechanical property of the printed article, and apply buffering logic to the generated reinforcement guidelines to generate buffered reinforcement zones, wherein the generated buffered reinforcement zones correspond to the generated reinforcement-aware toolpath used to print the at least one layer.

In certain embodiments, the system can include a motor and an extruder coupled to the motor, wherein the extruder comprises a heater and a nozzle, wherein the heater is configured to melt filament received by the extruder, and wherein the processor is configured to control movement of the extruder to deposit the melted filament along the generated reinforcement-aware toolpath. In other embodiments, the processor applies Minkowski-based expansion logic to at least two islands and a connected geometry skeleton to generate the buffered reinforcement zones. In some embodiments, the processor applies one or more of polygonal offsetting, Boolean union or Boolean intersection to generated the buffered reinforcement zones. In some configurations, the reinforcement-aware toolpaths are generated across at least two separate layers of the printed article to be deposited, wherein each of the layers is assigned a single load-boundary pair.

In another aspect, a non-transitory computer readable medium has instructions stored thereon, wherein the instructions, when executed by a processor, cause the processor to decompose a received geometric model into a group of individual layers, and, for at least one layer of the decomposed group of individual layers, the processor generates reinforcement guidelines using a geometry skeleton or simulation-driven design optimization applied to the at least one layer to increase at least one mechanical property of the printed article, and wherein the processor applies buffering logic to the generated reinforcement guidelines to generate buffered reinforcement zones, wherein the generated buffered reinforcement zones correspond to the generated reinforcement-aware toolpath used to print the at least one layer of the printed article.

In certain embodiments, the instructions, when executed by the processor, cause the processor to control movement of an extruder to deposit melted filament along the generated reinforcement-aware toolpath. In some examples, the instructions, when executed by the processor, cause the processor to apply Minkowski-based expansion logic to at least two islands and a connected geometry skeleton to generate the buffered reinforcement zones. In other examples, the instructions, when executed by the processor, cause the processor to apply one or more of polygonal offsetting, Boolean union or Boolean intersection to generated the buffered reinforcement zones. In some examples, the instructions, when executed by the processor, cause the processor to generate the reinforcement-aware toolpaths across at least two separate layers of the printed article to be deposited, wherein each of the layers is assigned a single load-boundary pair by the processor.

In another aspect, a method for generating reinforcement-aware toolpaths used in an additive manufacturing printing system, wherein the method is based on a geometric model and filament material properties provided by a user is described. For example, the method comprises decomposing the received geometric model into a group of individual layers, determining if loads and supports exist in at least one layer of the group, wherein if loads and supports exist in the at least one layer of the group then: applying simulation-driven design optimization or geometric skeletons or both to the least one layer of the group to generate reinforcement guidelines for the group, and applying buffering logic to the generated reinforcement guidelines to generate buffered reinforcement zones, wherein the generated buffered reinforcement zones correspond to the reinforcement-aware toolpaths for printing the at least one layer of the group. If loads and supports do not exist in the at least one layer of the group then the method can generate toolpaths for the least one layer of group where loads and supports do not exist using regional boundary offset logic.

In certain embodiments, the regional boundary offset logic comprises applying a polygon as topology to a layer of the group where loads and supports do not exist, and generating a geometric skeleton for the polygon applied to the layer of the group where loads and supports do not exist, wherein the geometric skeleton is connected to boundary surfaces produced by offsetting of the geometric skeleton based on user input filament width and a number of outer walls for the geometric model, and wherein the generated toolpaths for the group where loads and supports do not exist corresponds to the produced boundary surfaces and the geometric skeleton.

In other embodiments, the geometric model is provided by a user or is generated using structural simulations. In some embodiments, the geometric model is decomposed into a plurality of islands, and wherein at least two of the plurality of islands are connected by the geometry skeleton. In some configurations, the buffering logic comprises Minkowski-based expansion logic applied to the at least two islands and connected geometry skeleton to generate the buffered reinforcement zones. In other configurations, the buffering logic comprises polygonal offsetting, Boolean union or Boolean intersection.

In some configurations, the reinforcement-aware toolpaths are generated across at least two separate layers of the printed article to be deposited, wherein each of the layers is assigned a single load-boundary pair. In other embodiments, the reinforcement-aware toolpaths are generated by enlarging the reinforced guidelines in a first layer using the buffering logic so the reinforcement-aware toolpath prints additional material in the first layer to increase mechanical strength in the first layer.

In some embodiments, for each group of individual layers with loads and supports, the method comprises generating the reinforcement guidelines using the geometry skeleton or simulation-driven design optimization applied to each of the decomposed group of individual layers to increase at least one mechanical property of the printed article, and applying buffering logic to the generated reinforcement guidelines in each of the decomposed groups to generate buffered reinforcement zones for each of the decomposed groups corresponding to the reinforcement-aware toolpaths used to print that decomposed group, and wherein the method comprises exporting the corresponding reinforcement-aware toolpaths for each group to a printer to print the printed article.

In another aspect, an additive manufacturing system comprises a processor programmed to decompose a received geometric model into a group of individual layers, determine if loads and supports exist in at least one layer of the group, wherein if loads and supports exist in the least one layer of the group then the processor applies simulation-driven design optimization or geometric skeletons or both to the least one layer of the group to generate reinforcement guidelines for the group, and the processor applies buffering logic to the generated reinforcement guidelines to generate buffered reinforcement zones, wherein the generated buffered reinforcement zones correspond to the reinforcement-aware toolpaths for printing the at least one layer of the group. If loads and supports do not exist in the least one layer of group then the processor generates toolpaths for the least one layer of the group where loads and supports do not exist using regional boundary offset logic.

In certain embodiments, the processor applies the regional boundary offset logic by applying a polygon as topology to a layer of the group where loads and supports do not exist, and generating a geometric skeleton for the polygon applied to the layer of the group where loads and supports do not exist, wherein the geometric skeleton is connected to boundary surfaces produced by offsetting of the geometric skeleton based on user input filament width and a number of outer walls for the geometric model, and wherein the generated toolpaths for the group where loads and supports do not exist corresponds to the produced boundary surfaces and the geometric skeleton.

In other embodiments, the system comprises a motor and an extruder coupled to the motor, wherein the extruder comprises a heater and a nozzle, wherein the heater is configured to melt filament received by the extruder, and wherein the processor is configured to control movement of the extruder to deposit the melted filament along the generated reinforcement-aware toolpath. In other embodiments, the processor applies Minkowski-based expansion logic to at least two islands and a connected geometry skeleton to generate the buffered reinforcement zones. In some embodiments, the processor applies one or more of polygonal offsetting, Boolean union or Boolean intersection to generated the buffered reinforcement zones.

In another aspect, a non-transitory computer readable medium has instructions stored thereon, wherein the instructions, when executed by a processor, cause the processor to decompose a received geometric model into a group of individual layers, determine if loads and supports exist in the group, wherein if loads and supports exist in the least one layer of the group then the processor applies simulation-driven design optimization or geometric skeletons or both to the least one layer of the group to generate reinforcement guidelines for the group, and the processor applies buffering logic to the generated reinforcement guidelines to generate buffered reinforcement zones, wherein the generated buffered reinforcement zones correspond to the reinforcement-aware toolpaths for printing the at least one layer of the group. If loads and supports do not exist in the least one layer of the group then the processor generates toolpaths for the least one layer of group where loads and supports do not exist using regional boundary offset logic.

In certain embodiments, the instructions, when executed by the processor, cause the processor to control movement of an extruder to deposit melted filament along the generated reinforcement-aware toolpath. In other embodiments, the instructions, when executed by the processor, cause the processor to apply Minkowski-based expansion logic to at least two islands and a connected geometry skeleton to generate the buffered reinforcement zones. In some configurations, the instructions, when executed by the processor, cause the processor to apply one or more of polygonal offsetting, Boolean union or Boolean intersection to generated the buffered reinforcement zones. In other configurations, the instructions, when executed by the processor, cause the processor to generate the reinforcement-aware toolpaths across at least two separate layers of the printed article to be deposited, wherein each of the layers is assigned a single load-boundary pair by the processor.

In another aspect, a method of generating non-planar toolpaths to provide a printed article comprising a non-planar surface and a plurality of through-holes is described. For example, the method comprises decomposing a geometric model into a group of individual layers, and, for at least one layer in a decomposed group of individual layers generating at least two distinct toolpath patterns that can be combined to form a selected through-hole geometry in the printed article when the printed article is printed, and mapping the at least two distinct generated toolpath patterns onto the non-planar surface to print the at least one layer.

In certain configurations, a first distinct toolpath pattern and a second distinct toolpath pattern are generated so a non-planar article with 3,960 through-holes can be generated using less than ten repositioning moves per printed layer of the non-planar printed article. In some embodiments, the geometric model (or a portion thereof) is provided by a user. In other embodiments, the printed article comprises a curved surface comprising the plurality of through-holes. In some configurations, the generated two distinct patterns are printed in succession to print the printed article with the plurality of through-holes. In other configurations, the mapping comprises surface projecting the distinct toolpath patterns onto a curved substrate. In other embodiments, the method includes generating non-planar G-code instructions that encode the projected distinct toolpath patterns. In some embodiments, the printed article comprises at least four through-holes per 100 cm². In other embodiments, the through-holes which are formed are rectangular. In certain embodiments, the through-holes are non-rectangular.

In another aspect, an additive manufacturing system comprises a processor programmed to decompose a geometric model into a group of individual layers, and for at least one layer of a decomposed group of individual layers, generate at least two distinct toolpath patterns that can be combined to form a selected through-hole geometry in the printed article when the printed article is printed, and map the at least two distinct generated toolpath patterns onto the non-planar surface to print the at least one layer.

In certain embodiments, a non-transitory computer readable medium has instructions stored thereon, wherein the instructions, when executed by a processor, cause the processor to: decompose a geometric model into a group of individual layers, and for at least one layer in a decomposed group of individual layers, generate at least two distinct toolpath patterns that can be combined to form a selected through-hole geometry in the printed article when the printed article is printed, and map the at least two distinct generated toolpath patterns onto the non-planar surface to print the at least one layer.

In another aspect, a printed article can be produced by printing a layer or all layers of the article using the methods and systems described herein.

Additional features, aspect, examples, configurations and embodiments are described in more detail below.

### BRIEF DESCRIPTION OF THE SEVERAL VIEWS OF THE DRAWINGS

Certain embodiments are described with reference to the accompanying figures in which:

FIG. 1 is a flow chart showing user inputs, toolpath generation and a printed article, in accordance with certain embodiments;

FIG. 2 is an illustration showing an article and an applied load for use in determining reinforced regions of the article;

FIG. 3 is a flow chart showing steps where reinforced region applications can be generated;

FIG. 4 is an illustration showing a reinforced region of a decomposed layer and a non-reinforced region of a decomposed layer;

FIG. 5 is an illustration showing skeleton generation between two islands;

FIG. 6 is an illustration showing application of buffering logic to the skeleton and islands of FIG. 5;

FIG. 7 is an illustration showing a multi-layer toolpath strategy that can be used for printing different layers;

FIG. 8A and FIG. 8B are images showing two layers produced from the model of FIG. 7;

FIG. 9 and FIG. 10 are illustrations using a unified toolpath strategy;

FIG. 11, FIG. 12 and FIG. 13 show a multi-volume slice (FIG. 11) that is exported as a region R1 (FIG. 12) and a region R2 (FIG. 13);

FIG. 14 is illustration where a decomposed layer can be used in combination with buffering logic to generate toolpaths based on user defined reinforcement regions;

FIG. 15 is a geometric model showing a number of subregions;

FIG. 16 is a topological truss graph showing principal directions;

FIG. 17 shows a slice of a shape which is then used to identify regions;

FIG. 18 shows a skeleton of a sliced layer;

FIG. 19 shows a skeleton connected to the boundary surfaces where loads and boundary conditions are applied;

FIG. 20 shows toolpaths within that are established by offsetting in or buffering of the skeleton and boundary;

FIG. 21 is an illustration showing subregions that intersect with a layer;

FIG. 22 is a projected graph showing nodes corresponding to each intersected subregion and a principal vector of the subregion projected onto a sliced layer;

FIG. 23 shows the principal directions on a graph node;

FIG. 24 shows vectors perpendicular to the principal direction (PPD);

FIG. 25 shows a node where lower principal stress is identified and then removed;

FIG. 26 a PPD of node j that is rotated by 180 degrees;

FIG. 27 shows the solutions of heat equations;

FIG. 28 shows an estimated geodesic distance that is generated based on filament width and the vectors on an entire layer;

FIG. 29 shows a simulation where a 3D-printed structure is simulated using three distinct material representations;

FIGS. 30 and 31 shows assembly used for a simulation and structural analysis;

FIG. 32 shows a layer-by-layer stress distribution map used to guide toolpath segmentation;

FIG. 33 shows surface-based structures with multiple through-holes;

FIG. 34 shows a user-selected curved surface that can be projected onto a planar domain, where the corresponding toolpaths are generated;

FIG. 35 shows toolpath models that can be used to provide a surface with through-holes;

FIG. 36 and FIG. 37 show a structure can be decomposed into an alternating sequences of Pattern A and Pattern B, which are printed in succession to reconstruct original geometry;

FIG. 38 shows a block diagram of certain components that can be present in a printing system;

FIG. 39 shows an extruder of a printing system that includes a heater and a nozzle;

FIG. 40 shows a nacelle liner;

FIG. 41 shows a turbine shroud;

FIG. 42 shows a heat shield;

FIG. 43 shows a high-temp panel with cooling holes on contoured surfaces;

FIG. 44 shows a curved sensor housing;

FIG. 45 shows a bleed air duct with venting holes;

FIG. 46 shows a rudder panel with holes;

FIG. 47 shows a conformal radome;

FIG. 48 shows an infrared sensor mount;

FIG. 49 shows a ballistic shield with holes for ventilation;

FIG. 50 shows a blast panel with dispersal ports;

FIG. 51 shows an underwater acoustic housing;

FIG. 52 shows a structural bracket with mounting holes;

FIG. 53 shows a gripper or end-effector;

FIG. 54 shows a drone body frame;

FIG. 55 shows a sensor integration plate;

FIG. 56 shows a deployable structure node;

FIG. 57 shows a battery cooling plate;

FIG. 58A shows a brake rotor;

FIG. 58B shows a brake pad;

FIG. 59 shows a dashboard air diffuser;

FIG. 60 shows a perforated seating panel;

FIG. 61 shows a helmet visor with airflow channels;

FIG. 62 shows a helmet liner with airflow channels;

FIG. 63 shows an orthopedic implant;

FIG. 64 shows a cranial plate;

FIG. 65 shows a surgical drill guide;

FIG. 66 shows a breathable prosthetic liner;

FIG. 67 shows a dental implant surgical jig;

FIG. 68 shows a perforated filter plate;

FIG. 69 shows a heat exchanger panel;

FIG. 70 shows combustion chamber liners;

FIG. 71 shows flanges and mechanical gaskets;

FIG. 72 shows tooling fixtures or clamping jigs;

FIG. 73 shows a smartwatch and fitness band casing;

FIG. 74 shows a sports helmet;

FIG. 75 shows a speaker enclosure;

FIG. 76 shows an acoustic panel;

FIG. 77 shows a wearable exoshell or brace;

FIG. 78 shows a ergonomic chair back; and

FIG. 79 shows a molded seat cushion.

It will be recognized by the person of ordinary skill in the art, given the benefit of this disclosure, that certain dimensions or features in the figures may have been enlarged, distorted or shown in an otherwise unconventional or non-proportional manner to provide a more user friendly version of the figures. No particular layer thickness, width, length or material is intended to be required in view of the illustrative depictions which are shown in the drawings. Further, relative sizes of the figure components are not intended to limit the sizes of any of the components in the figures. Where dimensions or values are specified in the description below, the dimensions or values are provided for illustrative purposes only. The exact toolpath, material used, shape, geometry and the like of any final produced articles or parts can vary depending on the particular parameters and resulting properties which are desired.

### DETAILED DESCRIPTION

Certain embodiments are described below with reference to singular and plural terms in order to provide a more user friendly description of the technology disclosed herein. These terms are used for convenience purposes only and are not intended to limit the toolpath methodologies and other subject matter as including or excluding certain features unless otherwise noted as being present in, or excluded from, a particular embodiment described herein.

In certain configurations, the systems and methods described herein can be used to generate anisotropic toolpaths which can be used, for example, in 2D, 2.5D or 3D printing processes to produce layers that when combined provide printed articles. Filament, which is used as a printing material that is melted and then printed onto a surface in liquid form, typically has directional strength. This directional strength can be used to enhance load distributions, improve strength/stiffness or otherwise provide desired mechanical properties to the printed article. Anisotropy typically results from the printing process as the material is deposited in layers. Layering of the materials can result in different strengths in the layer, e.g., the x-y plane, compared to the strength in the z-direction, e.g., as a result of the materials being present in different layers. The parts strength and stiffness, therefore, are not necessarily uniform in all directions and can be affected by the orientation of the materials, e.g., filaments, in different layers and the movement of the tool during printing. The printed part can fail under certain applied loads depending on the exact direction the load or stress is applied to the printed part, since strength in certain directions may be significantly lower than in other directions.

In certain configurations, certain methods and systems can use a simulation-driven design optimization. As used herein, “simulation-driven design optimization” refers to a design methodology in which physics-based simulations—including, but not limited to, finite element analysis and machine learning-enabled predictive simulations—are integrated with optimization algorithms or generative design techniques to produce and evaluate candidate geometries or toolpaths. This methodology includes, without limitation, topology optimization, shape and size optimization, principal stress-based vector field generation, and pattern-based toolpath synthesis aligned with mechanical or functional performance criteria. The simulation-driven design optimization can be used in combination with images, shapes or partial portions thereof to predict toolpaths that provide a desired result, e.g., fewer repositioning events, use of less material, the provision of reinforced areas based on mechanical loads or stresses that the article may experience, etc.

In certain embodiments, planar and non-planar toolpath optimizations can be produced using the systems and methods described herein to provide different attributes depending on the parameters selected or desired. For example, buffer zones in reinforcement regions can be generated and used to enhance mechanical properties. A reduction in an amount of material, which still providing a selected mechanical strength and properties, in reinforced regions can be used. Toolpath lifting events can be reduced significantly comparted to existing methodologies to reduce print time and potential voids or gaps in the resulting printed articles.

In some embodiments, toolpaths can be generated in a layer-by-layer process or can be generated based on multi-layer toolpaths. Reinforcement-aware segmentation and anisotropic alignment of printing paths in additive manufacturing processes can be employed in the toolpath generation. While the exact steps and ordering of the steps can vary as noted below, in general user-defined geometric models along with specific mechanical parameters, boundary conditions, and anisotropic material properties are used to generate an appropriate toolpath to provide a final article with selected mechanical properties. For example, a geometric model can be decomposed into a plurality of layers, and each layer (or group of layers) of a geometric model can be analyzed to determine regions requiring reinforcement, identified either via simulation-driven design optimization or geometric skeleton extraction methods. Buffering logic, e.g., Minkowski-based geometric expansion logic or other buffering logic as noted below, can be applied to these guidelines or regions to define buffered zones, guiding precise anisotropic toolpath generation aligned explicitly with principal stress directions obtained from structural simulations. Further, structural simulations directly coupled with real filament path orientations and anisotropic material distributions, iteratively refining toolpaths to minimize stress concentrations and enhance structural performance can also be implemented if desired. The systems and methods supports multi-layer strategies, distributing loads and boundary conditions optimally across layers, or unified toolpath strategies that maximize reinforcement material deposition per layer for high-performance applications. Various illustrations of different methodologies to generate these toolpaths are described in more detail below. The toolpath generation which applied buffering logic can implement one or more of Minkowski-based geometric logic (or other buffering logic) into toolpath design, user-defined or algorithmically identified reinforcement zones using skeletons or simulation-driven design optimization, layer-based model generation for multiple regions, multi-layer and unified toolpath strategies based on load distribution and support conditions, use of principal stress vectors and heat equation-based smoothing for anisotropic toolpath generation, pattern-based optimization for multi-loads and support part and/or structural simulations tied to real filament paths and directional properties. The exact number and type of operations used to generate the toolpath can vary depending on the user input, the materials used and the desired or selected properties for the printed article.

In embodiments which use buffering logic to generate reinforcement-aware toolpaths which can be used in additive manufacturing processes, a user typically provides a geometric model (or portion thereof) and materials/material properties desirable for use in producing a printed article. The model can be an image, coordinates or selected or otherwise created through a user interface. The geometric model is then decomposed into a group of individual layers. For example, a layer-by-layer approach can result in certain layers which are the same as other layers. Similar layers can be grouped together, so the toolpath generation need only be performed for one layer of the group and then applied to other similar layers in the group. For at least one decomposed layer in the group, reinforcement guidelines can be generated using geometric models, e.g., a geometry skeleton or simulation-driven design optimization, to identify areas in need of reinforcement based on the mechanical load that will be applied to the final printed article. The generated reinforcement guidelines can then be used in combination with buffering logic to generate a toolpath for printing that layer. For example, buffering logic can result in geometric expansion to generate buffered reinforcement zones in the layer to be printed. These buffered reinforcement zones can correspond to the toolpath(s) used to deposit the material during production of that layer or group of layers to ensure appropriate material has been deposited, at appropriate regions, to account for the mechanical stresses which will be applied to the printed article. This methodology can extend part lifetime and reduce the likelihood of part failure.

In other configurations, optimized non-planar additive manufacturing methods, projecting non-planar surfaces onto planar domains and decomposing these into minimal repeating toolpath patterns can be provided. These patterns, selectively recombined, significantly reduce print-head repositioning events and improve efficiency, particularly in complex multi-featured geometries such as aerospace acoustic liners and other structures which include void space or through-holes. The optimized planar toolpaths can be mapped back onto original non-planar surfaces to produce highly efficient non-planar G-code or M-code instructions, enhancing surface quality and reducing overall manufacturing time. This approach can assist, for example, in ensuring improved mechanical integrity, reduced material usage, optimized printing efficiency, and superior geometric fidelity across both planar and non-planar additive manufacturing applications.

In certain configurations were non-planar toolpaths are generated and used to provide a printed article comprising voids or through-holes, a geometric model can be decomposed into a layer or group of individual layers. As noted herein, groups of layers include layers which are similar, e.g., have similar material distribution and/or mechanical properties. For at least one of the layers in a group, two or more distinct toolpath patterns can be generated. These toolpath patterns, when combined, form a selected through-hole or void geometry when the printed article is printed. The two or more distinct toolpath patterns can be mapped or projected onto a non-planar surface to print a printed article with significantly fewer tool repositioning events, e.g., print head lifts. For example, using existing methods to produce printed articles with voids, tool repositioning events are common and may result in N+1 repositioning events per layer where N is the number of voids or through-holes in that layer, e.g., in the case of four holes at least five repositioning events are required, as additional toolpath segments are needed to print infill material within empty regions. By generated at least two distinct patterns and printing material using the two distinct toolpath patterns in succession, the number of repositioning events can be reduced drastically. For example, for a four hole printed article by successive printing of the patterns, the number of repositioning events would be two. Repositioning events in conventional printing systems are further increase when hundreds or thousands of through-holes are present in the printed article. Since repositioning events occur during printing of each layer, the printing time to print a printed article with a hundreds or thousands of through-holes can be so long that printing of such parts is not commercially reasonable. Further, each time the print head is repositioned, there is a chance that voids or gaps in the material can result, which can lead to decreased overall strength and premature part failure.

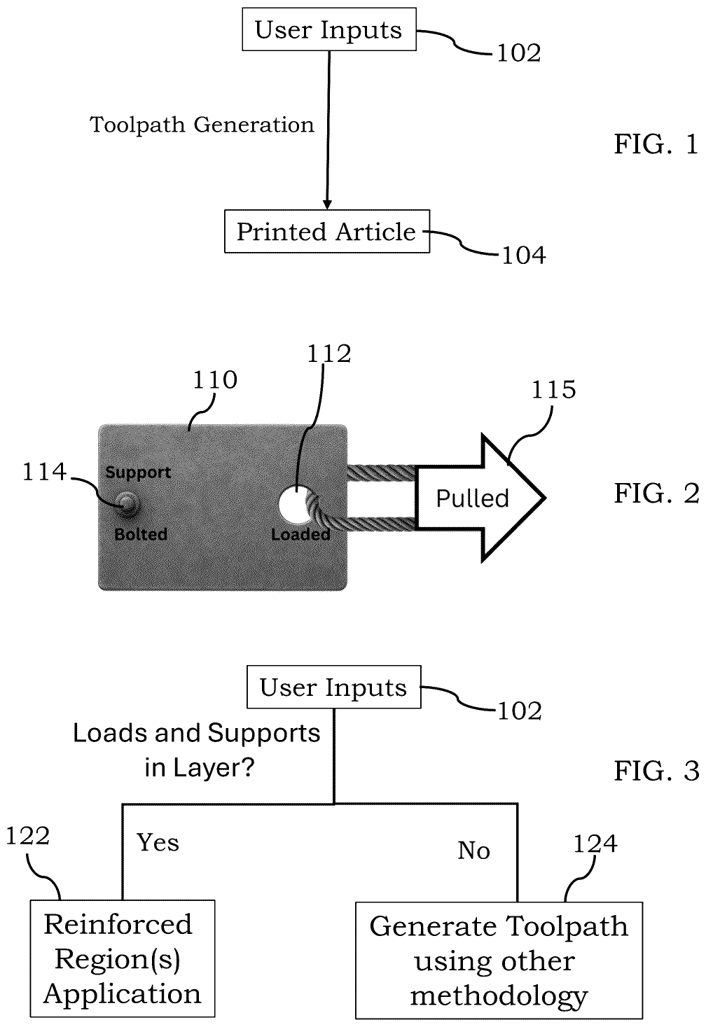

In certain embodiments, the methods described herein can use a combination of user inputs and generated toolpaths to provide a printed article as shown in FIG. 1. User inputs can be entered at step 102 and used in the toolpath generation process. Once the toolpaths are generated, the toolpaths can be implemented to produce the printed article 104. The exact user inputs can vary and can include, but are not limited to, the materials to be used, mechanical properties of those materials (if unknown by the system/method), the shape of the part to be printed, geometric regions of a part to be printed, the resulting mechanical parameters of the part to be printed and the like. In some examples, a print system can include a menu and/or database which includes the materials and material properties, and the user can select the appropriate information from a menu. The toolpath generation process can, in one embodiment, use the user inputs along with one or more of mechanical analysis to identify optimized load transfer paths and/or geometric computations such as offset operations or other operations mathematically equivalent to geometric expansion e.g., Minkowski-based expansion and intersection logic (Minkowskische Addition und Subtraktion beliebiger Punktmengen und die Theoreme von Erhard Schmidt). These operations can be applied, for example, to both user-defined geometric regions and automatically generated geometric skeletons of the input shape to determine reinforcement zones and material layout boundaries. Specifically, buffered zones are generated to simulate directional expansion of toolpaths, and the results can be used to define anisotropic material domains for simulation and optimization. While Minkowski-based expansion and intersection logic can provide desired buffered zones, equivalent implementation that leverage polygonal offsetting, buffering, or Boolean union/intersection for the purpose of load-guided material placement and toolpath adjustment could be used instead or in addition to Minkowski-based expansion. Polygonal offsetting can include creating a new polygon by shifting the original polygon's boundary outwards or inwards by a specified distance. This process can be applied to both 2D and 3D polygonal models and can be used for various purposes including creating margins, padding, or offsetting labels from polygon boundaries. A Boolean union, for example, can combine two or more objects into a single, larger object, retaining all the parts/regions of the original objects. Conversely, a Boolean intersection creates a new object consisting only of the overlapping areas or volumes of the original objects. While buffered zones are typically larger than the geometric skeleton that connect islands (as shown below), it is possible to reduce the overall size of the buffer zones where area of the part to be produced do not experience significant stress or mechanical loads. Methods used to generate buffered reinforcement zones are generally referred to herein collectively as “buffering logic.”

In some embodiments, the exact number and type of user inputs that are used in the toolpath generation process can vary depending on the desired properties of the printed article or part. In one instance, the user inputs can include one or more of part images or geometry, print specifications such as layer thickness, filament width, minimum length of filament, minimum radius of filament, print direction, the number of outer wall layers (N_wall), and resolution (N). Boundary conditions such as loads and supports, and material properties such as Young Modulus in X direction, Young Modulus in Y direction, Young Modulus in Z direction, Poisson Ratio XY, Poisson Ratio YZ, Poisson Ratio XZ, Shear Modulus XY, Shear Modulus YZ, and Shear Modulus XZ can also be entered and used in the toolpath generation process.

In certain embodiments and to illustrate toolpath generation using a simplified model, an illustration of an article and an applied mechanical load direction is shown in FIG. 2. The printed article 110 includes a generally planar body with two holes 112, 114. A first hole 112 can be used to couple to another component (not shown) which applies a load or stress to the part 110 in the direction of arrow 115. A second hole 114 with a bolt can be used to attached the printed part 110 to an underlying support structure (not shown). To determine desired toolpaths to print the part 110, user inputs including the material to be printed, the dimensions/geometry of the part to be printed, the load to be applied and other parameters as noted herein can be entered by a user. The methodology can then analyze the entered parameters in a layer-by-layer process and provide planar or non-planar toolpaths depending on the particular part to be printed. For example, the overall geometry of the part to be printed can be decomposed into individual layers consistent with the layer thickness achievable using a selected printer. Each decomposed layer can be categorized/analyze to determine if (1) both loads and supports exist in the selected layer or (2) no loads or supports exist in the selected layer. An illustration is shown in FIG. 3 of one model where if loads and supports in the particular layer are present, then the process can apply reinforcement regions or zones with the layer at a step 122. If no loads or supports exist in the selected layer, then different processes can be used (as noted in more detail below) at a step 124.

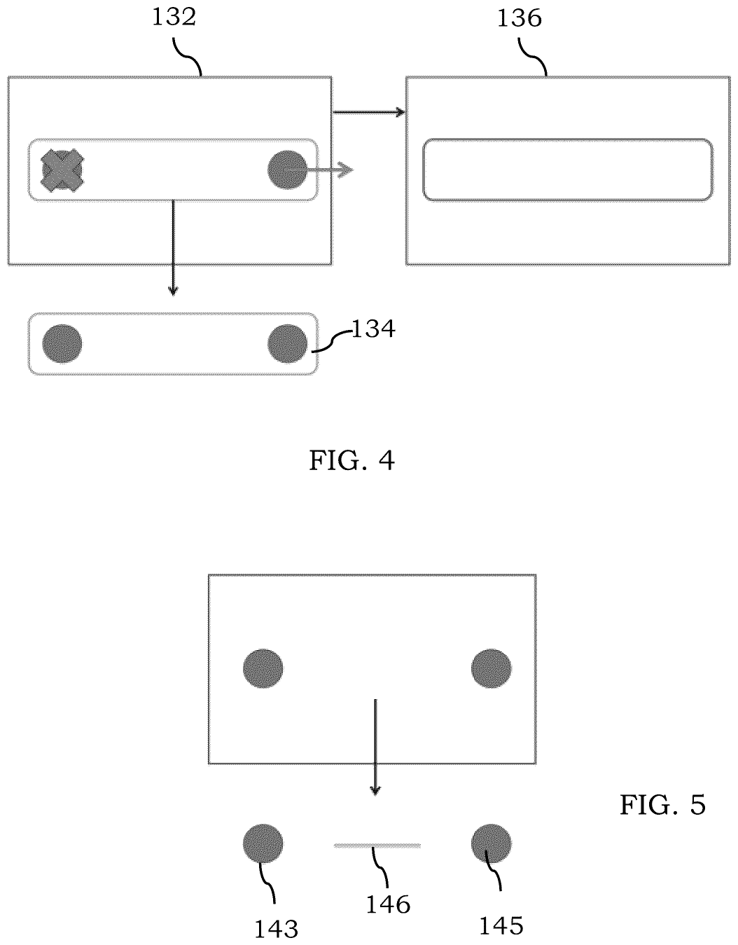

Referring to FIG. 4, if reinforced regions or zones are applied to layers where loads and supports exist in a decomposed layer (or a group of decomposed layers), then at least one reinforcement region/guideline within that layer 132 can be applied. For example, a reinforced region 134 and a secondary regions 136 are shown in FIG. 4. The region 132 is designated for the placement of additional reinforcement material (e.g., additional filament), while the region 136 represents non-critical areas which may be considered mechanically insignificant under the desired mechanical loading conditions.

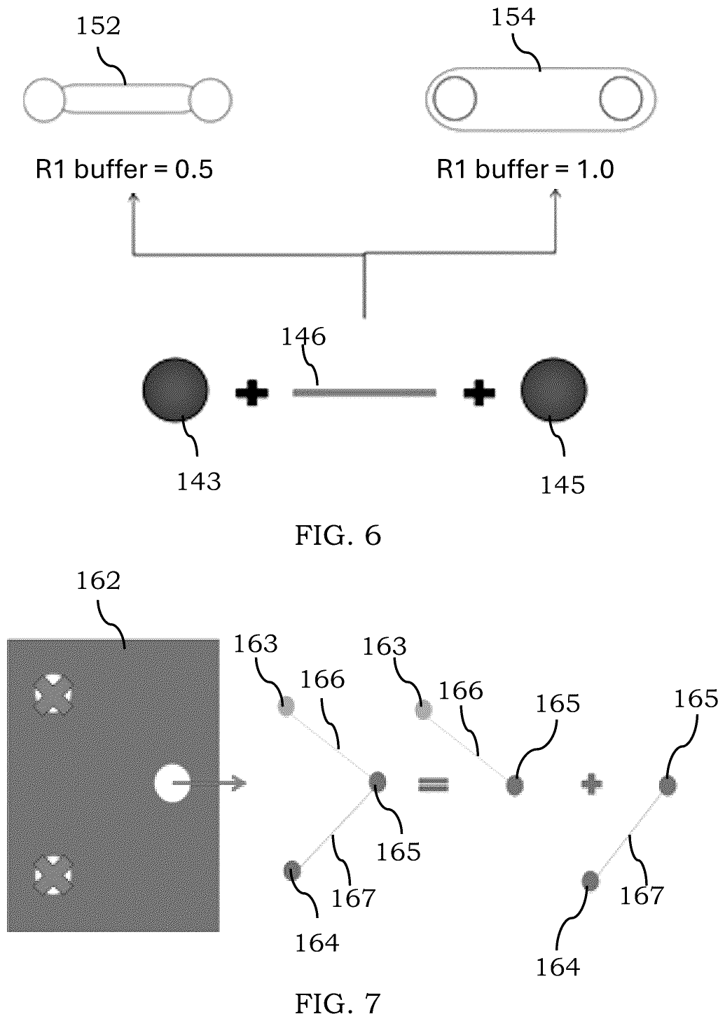

In certain embodiments, different approaches can be utilized to identify these different regions. For example, simulation-driven design optimization or the use of geometric skeletons to identify multiple regions can be implemented. In simulation-driven design optimization, each individual layer undergoes a 2D simulation-driven design optimization to identify reinforcement regions within sufficient conditions for 2D simulation-driven design optimization. When using geometric skeletons to identify reinforcement regions, for a layer without sufficient conditions for 2D topology, a 2D geometric skeleton can be computed. Referring to FIG. 5, a geometric skeleton 146, along with internal islands 143, 145, can be identified and then processed using buffering logic to geometrically expand the reinforced guideline regions, e.g., a Minkowski sum computation or other similar buffering logic can be applied. The exact geometric skeleton provided can be based, at least in part, on desired article performance including stiffness and strength. In one example, a Minkowski sum can be implemented by adding each point of one shape to each point of the other shape. Depending on the shapes used, e.g. convex or non-convex shapes, the sums can be computed in linear time. A buffer parameter is provided to the user to control the extent of reinforcement in the skeleton 146 and islands 143, 145, and this process results in a buffered reinforcement zones R1 as shown in FIG. 6 (Minkowski sum representation). A buffered reinforcement zone 152 is produced when an R1 buffer of 0.5 is applied to the skeleton 146 and islands 143, 145. A buffered reinforcement zone 154 is produced when an R1 buffer of 1.0 is applied to the skeleton 146 and island 143, 145. A buffer, in the context of the methodology described in connection with FIG. 6, is a way to create a buffer volume around a reinforcement region by adding a shape to it using the Minkowski sum. In general, the larger the buffer the larger the added shape. The user can select the buffer to be added to produce the reinforcement zone with typical buffers being between 0.1 to 1 or 0.2 to 0.9 or 0.1, 0.2, 0.3, 0.4, 0.5, 0.6, 0.7, 0.8, 0.9 or 1.0. The exact buffer can be selected to enhance reinforcement within the buffered reinforcement zone while at the same time minimizing the use of non-necessary material which may not be needed under the desired mechanical load conditions. The methodology just described, or similar methods to Minkowski sums as noted herein, can be used to generate buffered reinforcement zones in one or more layers.

In other configurations, it may be desirable to implement multi-layer toolpaths where multiple layers have multiple loads or supports. For example, printed articles with complex geometries and different mechanical strengths at different areas can be printed using multi-layer toolpaths. If multiple layers include multiple loads or support and a user selects to have varying toolpaths in different layers, then graph-theoretical algorithms implemented by a shortest paths finding algorithm, including but not limited to Dijkstra's algorithm for shortest path computation, Kruskal's algorithm for minimum spanning tree generation, and connected component analysis based on depth-first or breadth-first traversal can be used. These algorithms can be integrated into the toolpath optimization process for additive manufacturing, where graph nodes represent discrete geometric or mechanical zones and edges encode toolpath continuity or stress-flow relationships. Application-specific structuring of graph topologies based on simulation-driven material layouts, and the algorithmic use of path or tree structures to minimize material use while preserving directional stiffness and load transfer efficiency can be implemented. Distributing multiple load and boundary condition pairs across multiple 3D printing layers ensures that each layer contains at least a minimal buffered reinforcement zone R_1, e.g., a minimal buffered reinforcement zone exists in each layer while still achieving the desired mechanical properties. For example, each layer can be assigned a single load-boundary pair, which effectively reduces material usage in each layer. This arrangement is particularly beneficial for systems equipped with reinforcement-capable printers.

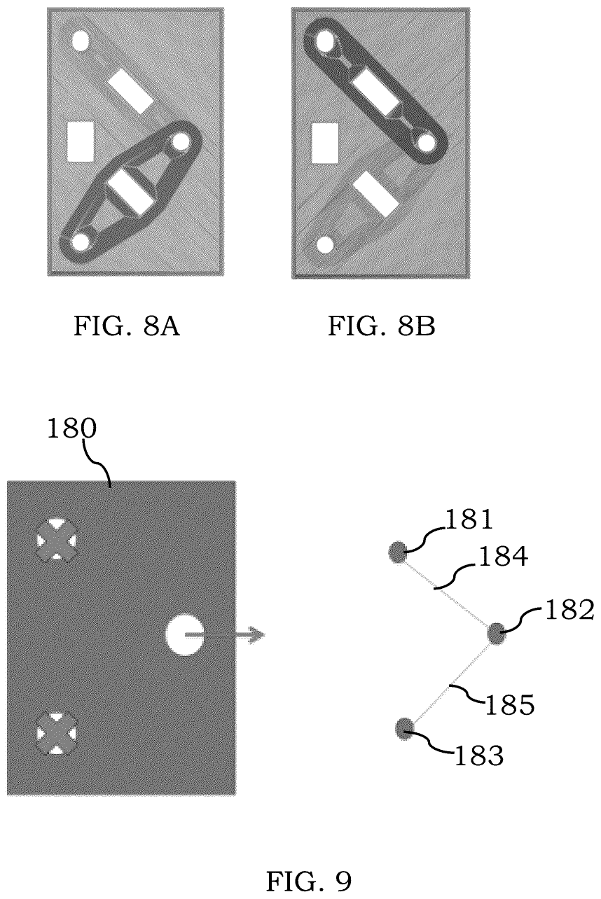

One illustration of a multi-layer toolpath strategy is shown in FIG. 7 using a layer 162 from an article to be printed. A layer 162 results from the decomposition of the geometric shape provided by a user into a plurality of individual layers (or groups of similar layers) to generate islands 163, 164 and 165 with a geometric skeleton 166 between island 163 and 165 and a geometric skeleton 167 between islands 164 and 165. Buffering logic can be applied to generate buffered reinforcement zones (as noted herein) for each island/skeleton grouping. This arrangement can be used to print the buffered reinforcement zones in different layers as shown in FIGS. 8A and 8B.

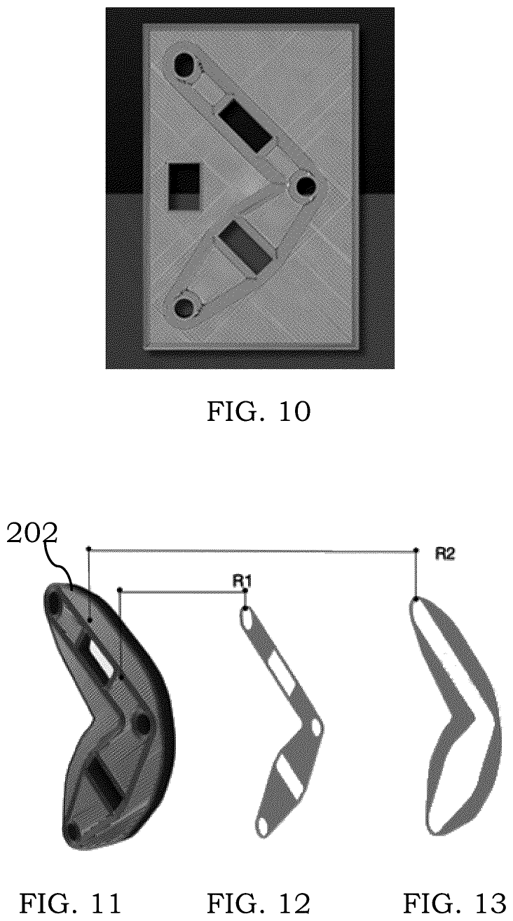

In some embodiments, it may be desirable to implement a unified toolpath strategy to produce the printed articles. For example, for applications where maximum mechanical performance is prioritized over cost and weight—such as high-end or mission-critical parts—a unified toolpath strategy would aim to introduce as much reinforcement material as possible within a single layer or to enlarge the buffered reinforced zones. An illustration is shown in FIGS. 9 and 10. Referring to FIG. 9, a layer 180 (resulting from decomposition of a user provided geometric shape into a plurality of layers) can be processed to provide island 181, 182 and 183. A geometric skeleton 184 is generated between islands 181, 182, and a geometric skeleton 185 is generated between islands 182, 183. Buffering logic can then be applied to generated buffered reinforcement zones. A single unified toolpath to print the buffered reinforcement zones can then be implemented to print the layer as shown in FIG. 10. Note that the buffer value applied to the geometric skeleton 185 between islands 182, 183 is larger than the buffer value applied to the geometric skeleton 184 between the islands 181, 182.

In certain embodiments, to generate the toolpaths used by the printer from generated buffered reinforcement zones, each decomposed layer with identified buffered reinforcement zones where applicable can be exported to provide a multi-volume representation of the article to be printed. For example, separate stereolithography (STL) or computer aided design (CAD)-format files can effectively guide any existing commercial slicing software to apply optimized printing strategies specifically within the buffered reinforcement zones. The STL or CAD files generally include the surface geometry of the layers including any buffered reinforcement zones to be printed. Toolpaths which correspond to the buffered reinforcement zones can be exported as G-code, M-code or similar code to guide the system to print the layer using the generated toolpath(s). An illustration is shown in FIGS. 11, 12 and 13 where a multi-volume slice 202 (FIG. 11) is exported as a region R1 (FIG. 12) and a region R2 (FIG. 13). Printing of the different regions R1 and R2 can produce the slice 202 on a print bed or other printing surface.

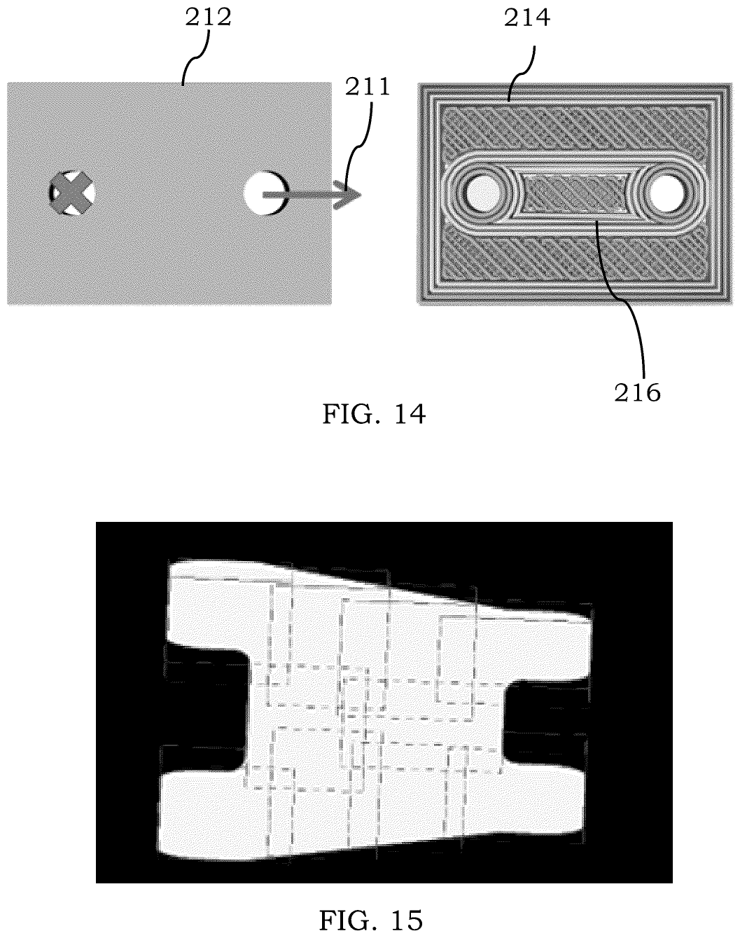

In certain configurations, a user may specifically define reinforcement regions within the user input values. For example, while the steps described above can generate optimized regions based on applied loads, supports, and material properties, the user could instead define regions or modify the generated regions by the algorithms, by specifying portions of the shape which need reinforcement or other methods. A reinforced region can also be defined based on user-specified areas drawn directly in the CAD frontend of the software or otherwise provided as an image with reinforcement regions which are specified. FIG. 14 shows an illustration where a decomposed layer 212 can be used in combination with buffering logic to generate toolpaths based on user defined reinforcement regions 216 (elliptical shape) and 214 (rectangular shape). In this example, the user specified reinforcement regions 14, 216 based on there being an applied mechanical load in the direction of the arrow 211. The generated toolpaths including the buffered reinforcement zones can be exported to a printing system and used to print the layer 212 with selected reinforcement regions.

In certain configurations, toolpaths can be generated based on methodologies other than regional boundary offsets. In such instances, structural simulations can be performed to solve mathematical models. While structural simulations are described in more detail below, in general structural simulations can include solving a system of elasticity equations based on user input. The stresses are obtained after solving the elasticity equations, and the stress matrix is established. Then, eigenvalues and eigenvectors of the stress matrix are obtained. Principal stress values, maximum eigenvalues, principal directions, and the eigenvectors associated with maximum eigenvalues are computed and used to generate the toolpaths.

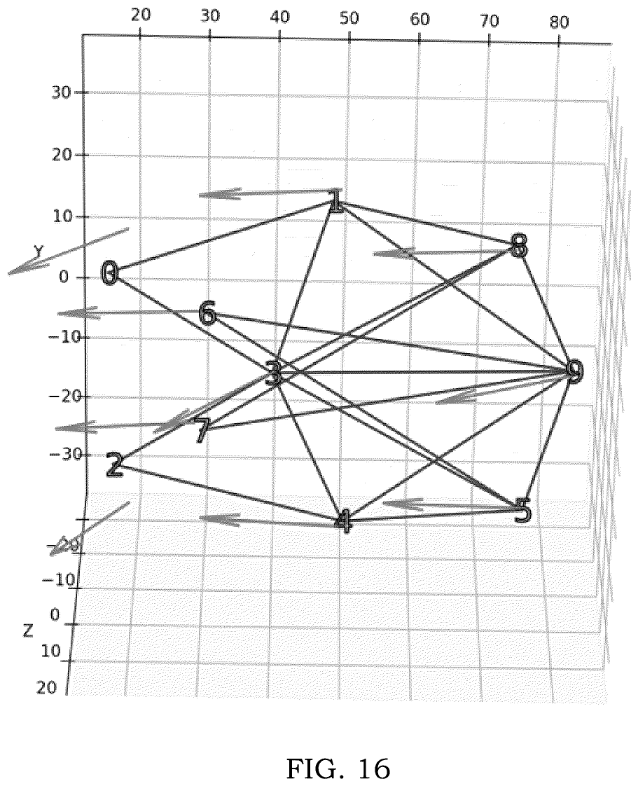

In performing a structural simulation based on a user input geometric model, the model can be decomposed based on a resolution input (N). N number of subregions are then established as shown in FIG. 15, where for this example ten subregions are shown using dashed lines for each subregion. A topological truss graph Gx can be produced by considering the mass center of a single subregion as a graph node and its connection to its neighbor's subregion's nodes is a graph edge. The principal stresses and principal directions inside each subregion are identified. For example, at least two approaches can be implemented. The first approach is to find the maximum principal stress within a subregion and identify its principal direction to establish one principal direction for each region. The second approach is to find the average of the principal direction within each subregion and choose this direction as the principal direction of the subregion. This principal direction is shown for the graph in FIG. 16 where the arrows represent the principal directions.

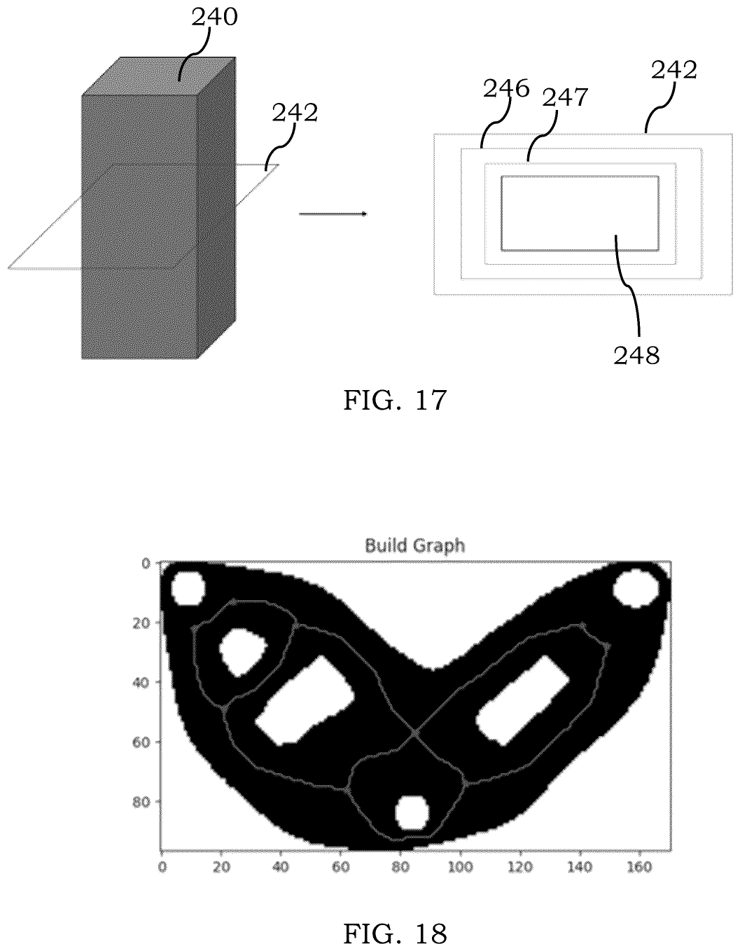

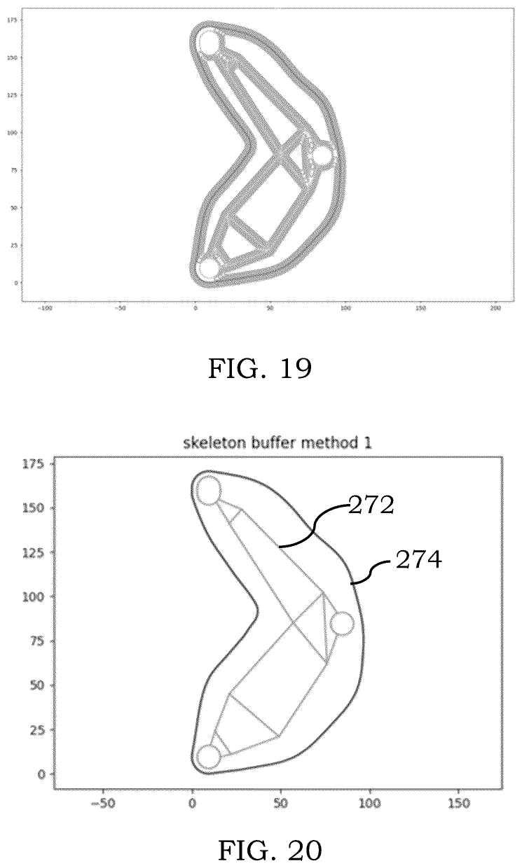

Based on the user input, such as the print directions (for the case of 2.5D), layer height, and model dimensions, the model can be decomposed/sliced into several layers (e.g., layer or polygon 242, shown in FIG. 17 for a CAD representation of the article 240). Each layer is a cut of the parameterized CAD model surface element format, e.g., STL. Each cut forms a closed polygon 242. Polygon 242 is then divided into regions, 246, 247 (collectively referred to below in this paragraph as Region R1) and 248; region 248 is an infill region (Polygon 242 minus Regions 246, 247). After the regions are defined, R1 (regions 246, 247 in FIG. 17) inherits the topology of the polygon 242. The toolpaths in this region are obtained by offset in or buffer the boundary of polygon 242 based on user input filament width and the number of outer wall layers (N_wall), The right image in FIG. 17 shows the repeated wall layers; the N_wall indicates how many outer wall layers exists. An alternative approach using polygon 242 could also be implemented. The geometric skeleton of the sliced layer can be obtained (FIG. 18), and then the line segments of the geometric skeleton are smoothened. Here, while not necessary, it is possible to make line segments straight. Then, the geometric skeleton is connected to the boundary surfaces (where the loads and boundary conditions are applied) as shown in FIG. 19. Then Region R1 and the toolpaths within the region are established based by offsetting in or buffering of the skeleton (shown as lines 272) and boundary (shown as line 274) based on user input filament width and the number of outer wall layers (N_wall) as shown in FIG. 20.

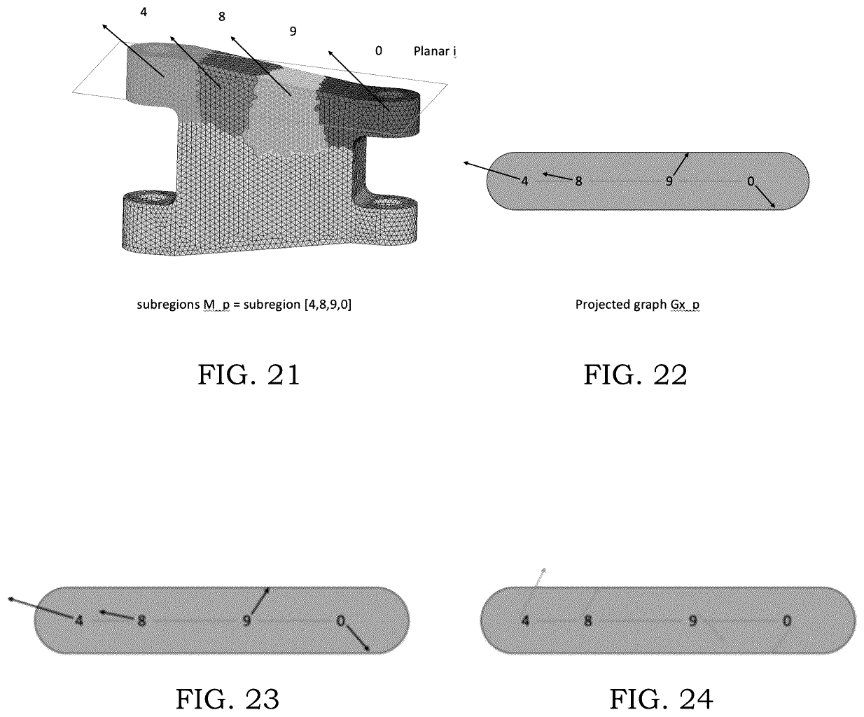

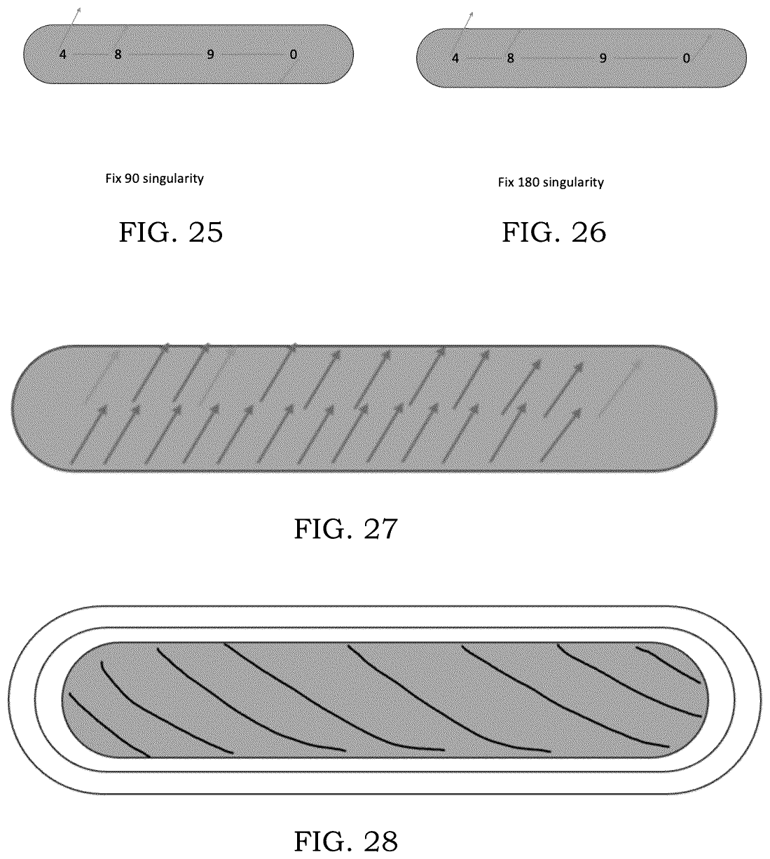

To determine the toolpaths in the infill region 248, the subregions that intersect with layer 242 can be identified (see FIG. 21). Then, the node corresponding to each intersected subregion and the principal vector of the subregion are projected onto the sliced layer (see FIG. 22). Then, the perpendicular vector to the principal directions and normal of the layer at each graph node is calculated. This is called perpendicular to the principal direction (PPD). FIG. 23 shows the principal directions on the graph node, and FIG. 24 shows the vectors perpendicular to the principal direction (PPD). Then the singularity points are identified. Here the edges from 3D graph with the sliced layer are identified and a weight Gx_p [edge number] is given to each edge. The weight is calculated based on the following equation, (1−((PPD at node 1)*(PPD at node 2))\hat{ }2). when weight_Gx_p for an edge close to 1 means high singularity. Then, the weight for each edge is found and the edges where weight Gx_p>threshold are found. The exact threshold used can be changed/selected by user. Typical threshold values are 0.2, 0.3, 0.4 or 0.5. For each edge with a weight greater than the threshold, the node with lower principal stress is identified and then removed (see the node labeled as “9” in FIG. 25). After all singularities are addressed, the node with the highest principal stress is identified. Then, the following multiplication is checked for every other node ((PPD at node with max principal stress)*(PPD at node j)), where j is the node number for other nodes. If the sign of the multiplication is negative, the PPD of node j is rotated by 180 degrees (see FIG. 26). At this stage, the corrected PPDs are established. Next the vectors in the entire layer are generated by solving the heat equations. To do this, the following heat equations are solved

$$\begin{matrix}\frac{d}{d t} {u}_{x} = ∇ \cdot ( ∇ {u}_{x} ) \\ \frac{d}{d t} {u}_{y} = ∇ \cdot ( ∇ {u}_{y} ) \\ \frac{d}{d t} {u}_{z} = ∇ \cdot ( ∇ {u}_{z} )\end{matrix}$$

with the PPDs in x-, y-, and z-directions are given as boundary conditions to solve the heat equations. The solution of the heat equations is shown graphically in FIG. 27. Finally, the estimated geodesic distance is generated based on filament width and the vectors on the entire layer (see FIG. 28). This information can be exported as a STL file, CAD file, G-code, M-code or other format which can be used by a printer to control a toolpath for printing this layer of the article. Each layer can be simulated in a similar manner, so a toolpath exists to print the printed article.

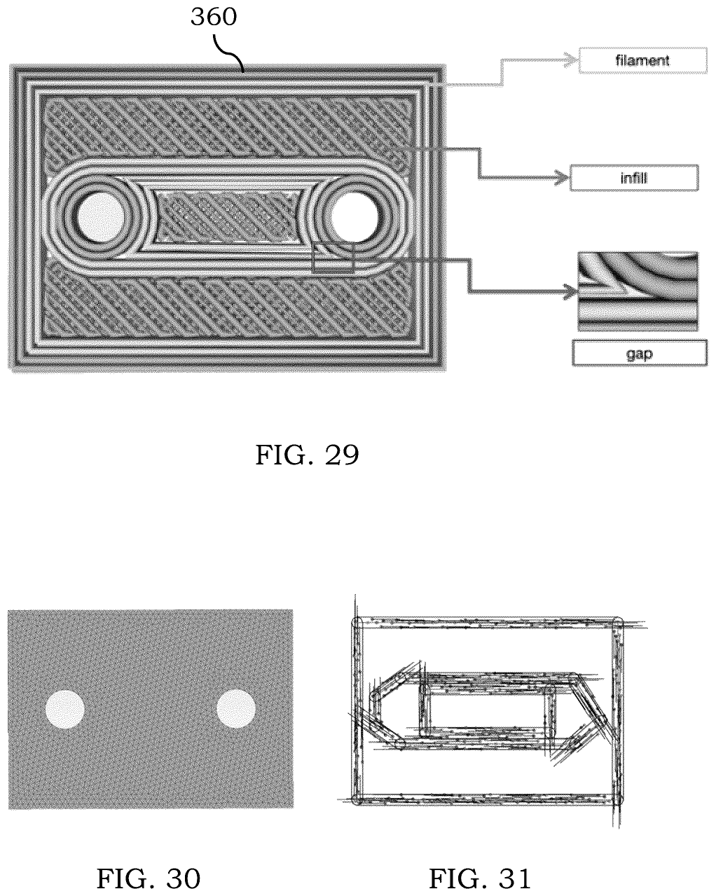

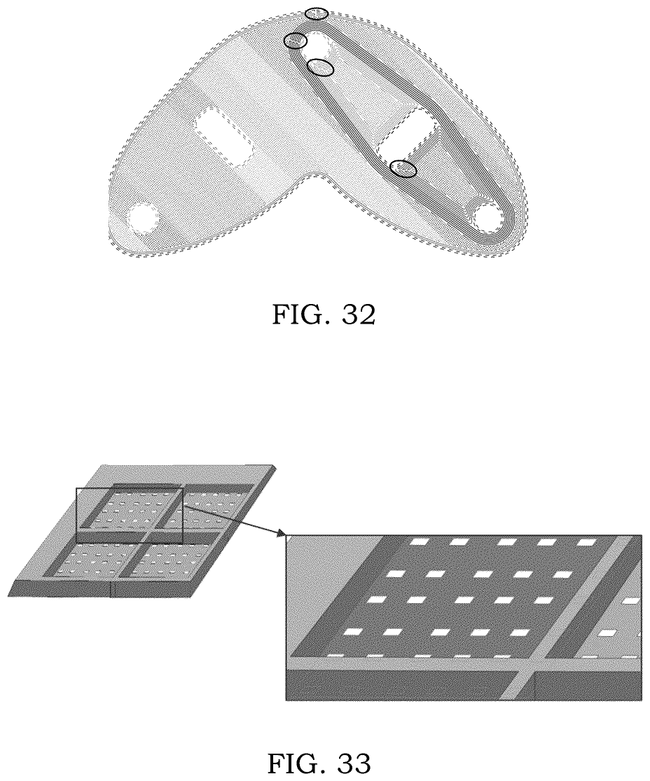

Structural simulations can also be performed based on complex geometries. Mesh elements can be assigned distinct material properties and orientations based on the slicing configuration of each individual printing layer. Once these anisotropic properties and directional orientations are properly established, structural mechanics simulations are performed on the 3D-printed parts. Using user-defined loads, boundary conditions, and anisotropic material inputs, the system solves elasticity equations to determine accurate stress distributions throughout the component. To accurately capture the anisotropic mechanical properties inherent in 3D printed components, the method can employ a unique, layer-wise element assembly strategy. This method explicitly assigns distinct material properties Cij and directional orientations θ to finite elements, based on the precise toolpath layout generated during slicing. A simulation is provided below where a 3D-printed structure is simulated using three distinct material representations: filament, infill, and gap (see FIG. 29 showing the different components for a layer 360). The filament represents reinforced regions or continuously printed material paths, the infill denotes the general filling material, and the gap characterizes voids or bubbles that can occur during the printing process. The orientation of the filament material is assigned according to the printing direction defined by the 3D printing toolpath. Based on the provided toolpath information, the material distribution and corresponding orientation in each region can be identified. This data is subsequently incorporated into the following formulation to establish the simulation framework.

$$C\_ij \hat{} θ = R \hat{} {T ( θ )}^{*} {C\_ij}^{*} R ( θ )$$

where the R(θ) is the rotation C_ij matrix. Some material properties, such as the stiffness tensor components, particularly for regions like gap, need to be experimentally determined and calibrated due to their nonstandard or uncertain mechanical behavior. Once all data is properly assembled (see FIGS. 30 and 31) structural analysis of the model can be performed using the simulation engine. The final layer-by-layer stress distribution map is used to guide toolpath segmentation. The resulting cutting points are strategically placed to avoid regions of stress concentration (see FIG. 32), thereby enhancing the overall structural integrity.

The methodologies described above to generate and use toolpaths are typically used where the layer to be printed is mostly continuous or includes only a few apertures or through-holes. In the context of printing articles where a plurality or through-holes or voids are present in the final printed article, non-planar toolpaths can be generated and used. For example, for surface-based structures with multiple through-holes (see FIG. 33), existing non-planar 3D printing algorithms are unable to achieve both high-quality and efficient fabrication. The methodology described herein can address this limitation by enabling a high-performance curved-surface 3D printing method. To achieve a smoother surface finish, slicing can be performed relative to a user-selected geometric surface, which may be non-planar or a designated face from a CAD model, serving as the slicing reference. For example, a user can input the following information: CAD file [stp, or iges]; print specifications such as layer thickness, filament width, minimum length of filament, minimum radius of filament, print direction, the number of outer wall layers (N_wall), and resolution (N); a user-selected geometric surface, which may be non-planar or a designated face from a CAD model, serving as the slicing reference.

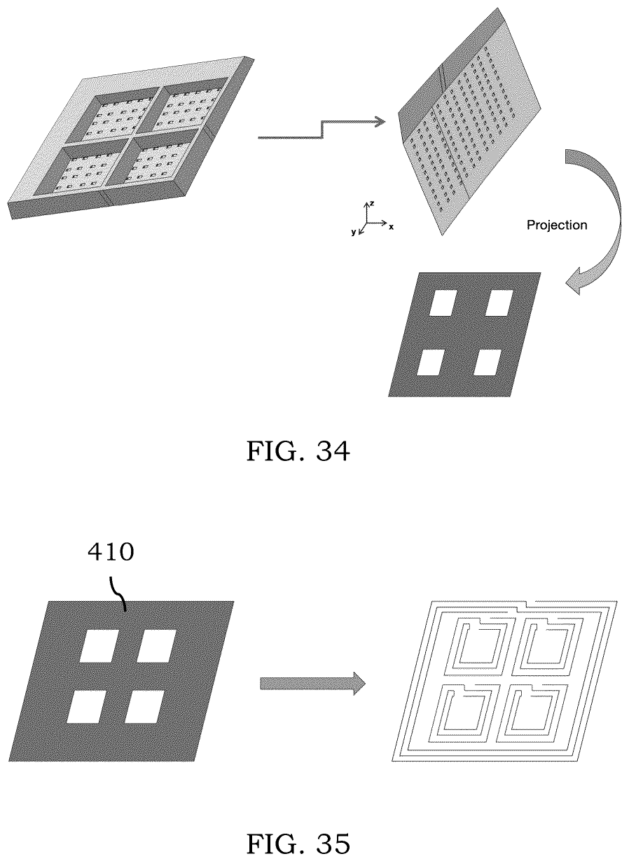

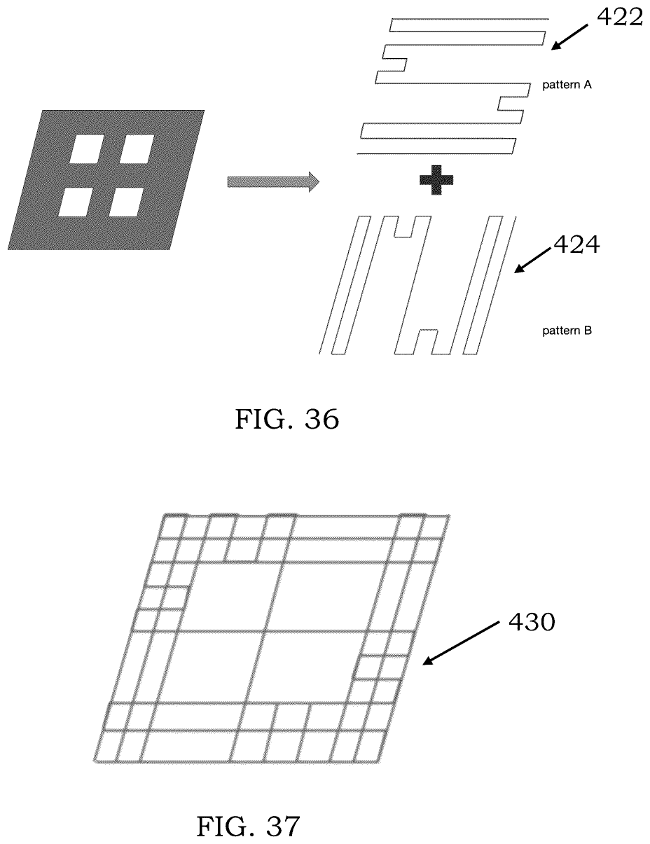

Several distinct patterns that can be combined to form the desired hole geometry can then be generated. For example, a user-selected curved surface can be projected onto a planar domain, where the corresponding toolpaths are generated, as shown in FIG. 34. Taking a shape 410 with four holes (see FIG. 35) as an example, conventional toolpath planning methods typically perform offsetting from the outer boundary and internal islands, and then connect contours of the same type into a single group. For a structure with N holes, this approach results in at least N+1 retractions (i.e., print head lifts) per planar layer. In the case of four holes in a layer, a minimum of five retractions is required, as additional toolpath segments are needed to deposit infill material within the empty regions of the layer 410 (see FIG. 35). For such multi-holed thin-shell structures, a better approach employs a specialized combination of repeating patterns to significantly reduce the number of lift-and-reposition moves. As illustrated below, the layer structure with a plurality of through-holes can be decomposed into an alternating sequence of Pattern A 422 and Pattern B 424, which are printed in succession to reconstruct the original geometry 430 (see FIGS. 36 and 37). Applying this methodology to a specific printed article, in the case of an acoustic liner panel used in an aircraft engine, the structure contains approximately 3,960 holes. Using conventional toolpath planning, producing this liner by printing would require at least 4,000 lift-and-reposition moves per layer, resulting in significant printing time and operational cost. In contrast, with the method described herein which used distinct pattern generation, the same structure can be printed with only seven (7) repositioning moves per layer, drastically reducing manufacturing time while maintaining geometric and functional fidelity. Subsequently, the computed 2D toolpath can be mapped or projected back onto the original reference non-planar surface through surface projection techniques. This mapping ensures geometric conformity between the toolpath and the curved substrate. Based on this projected path and the predefined pattern decomposition, the system generates a final non-planar G-code instructions, which encode the spatial orientation and extrusion direction for each segment in accordance with the surface geometry. The exact hole density can vary, e.g., from a few holes/100 cm² to over 100 holes/cm². In some examples, the hole density can be at least one hole/100 cm², two holes/100 cm², three holes/100 cm² or four holes/100 cm². Hole density need not be uniform and can be higher or lower in different areas of the printed article.

Periodic perforation structures—such as the parallelogram-shaped holes illustrated—are represented through a minimal set of reusable toolpath patterns. These patterns (e.g., Pattern A 422, Pattern B 424) serve as building blocks that can be combined to reconstruct complex multi-hole geometries. For instance, triangular perforations may be decomposed into Patterns A, B, and C, while pentagonal structures may require additional units such as Patterns D and E. Hexagonal layouts may be reproduced with as few as three base patterns. This pattern-based decomposition framework generalizes across various hole configurations and relies on the observation that many repetitive or semi-regular perforation topologies can be approximated via low-frequency Fourier components, which in turn correspond to a small number of directional toolpath segments, or “patterns,” as defined in this invention. The presented method allows complex perforation fields to be efficiently reproduced through deterministic and compact toolpath logic, resulting in significant reductions in lift moves, toolpath complexity, and print time. Any method that reconstructs periodic or quasi-periodic hole structures in additive manufacturing using pattern combinations derived from geometric decomposition, frequency-domain projection (e.g., Fourier-based analysis), or other low-dimensional basis functions for the purpose of toolpath simplification and optimization, shall be considered within the scope of this invention.

The various toolpath generation methodologies described herein can be used to generate toolpaths as noted herein. The resulting information can be provided to a printing system configured to use the generated information to print a printed article. While the exact nature of the printing system can vary, the printing system typically translates the information into G-codes to control a print head in a desired manner to print the article. For example, G-codes can represent linear movement, arc or circular movement, dwell or pauses, cubic splining movement, retraction of the print head, the movement units or other information. Alternatively, M-codes can be implemented and used to control a print head. In general, the G-codes or M-codes have a series of commands to control the printer. The methods described herein can provide layer-by-layer G-codes (or M-codes) which can be used by a printer to print the article. A series of commands can be implemented to print the printed article in a layer-by-layer process to provide printed articles with reinforced zones that include desired mechanical properties. Commercially available software which exists on the printer or a control system including a processor can use the received toolpath information in the printing process.

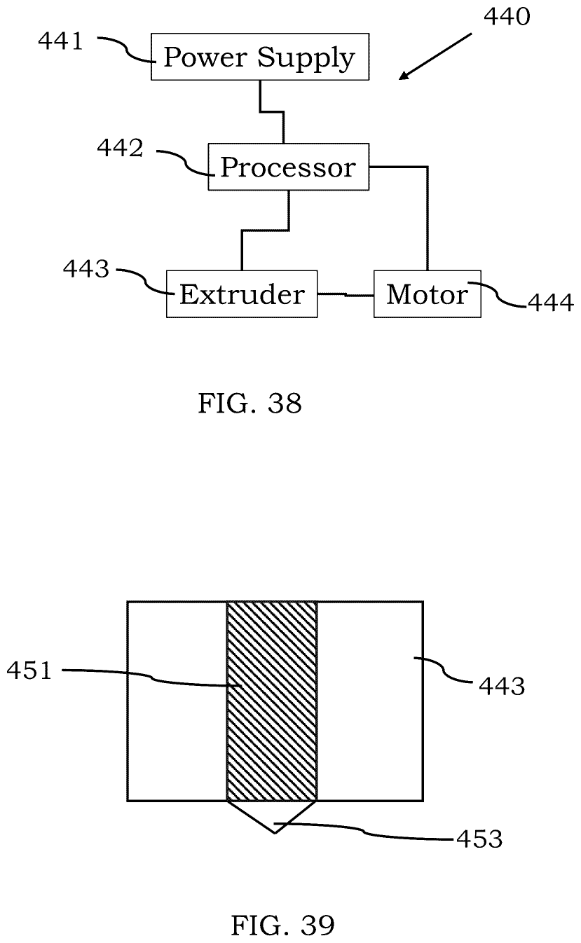

In certain embodiments, a simplified block diagram of a 3D printer system 440 is shown in FIG. 38. The 3D printer 440 typically includes a power supply 441, a processor 442, an extruder 443 and a motor 444. The extruder 443 is configured to remove plastic from a filament spool, force it through a heated chamber and then out a nozzle to print the material as a layer. Successive layers are printed onto each other to form a printed article. While the exact configuration of an extruder 4430 can vary, an extruder 443 typically includes a stepper motor (such as motor 444), a spring-loaded gear wheel to engage the plastic filament, a hot end to heat the filament, and a nozzle to dispense the heated filament onto a support structure such as a print bed. Three often used extruders are direct drive, Bowden and dual extruders. Direct drive extruders are typically mounted above the hot end and the nozzle. These types of extruders push the plastic directly into the heated end and out the nozzle. Bowden extruders are mounted in a fixed location on the a frame that retains the printer components. A Bowden extruder pushes the plastic through a long flexible tube to the hot end. This allows the printer to print faster since there is less weight near the nozzle. Dual extruders have two separate extruders next to each other that supply different materials. These materials can be different colors, or one extruder can be used to print the part supports. Both direct drive and Bowden-style extruders can be set up for dual extrusion. The printer components are typically positioned in a frame or housing (not shown) that has a print bed support structure (not shown) to receive filament (material used for printing) that is layered on the print bed to form a printed article. Most systems are configured to move in three axes of rectilinear motion, e.g., the extruder 443 and/or the print bed or both can move in x-, y- and z-directions. The motor 444 (or motors) control movement of the extruder 443 in the manner defined by the toolpath generation methods which are provided to the 3D printer as G-code. The printer also typically includes a user interface where a user can enter user inputs as noted herein.

The printer system is controlled by the processor 442 which can be used to generate the toolpaths as described herein. Alternatively, the toolpath generation can occur on a separate system with a processor and then be exported or otherwise sent to a 3D printer including the processor 382. The processor 382 is typically electrically coupled to a memory unit, storage or other electrical components. The processor 382 can be used, for example, to control the toolpath of the components of the printer system to print the printed article in a manner consistent with the toolpaths which are generated using the methods described herein. Such processes may be performed automatically by the processor without the need for user intervention or a user may enter parameters through a user interface present on a mobile device, a terminal, a display, a screen or other suitable interfaces. In certain configurations, the processor may be present in one or more computer systems and/or common hardware circuitry including, for example, a microprocessor and/or suitable software for operating the system. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Intel Core™ processors, Intel Xeon™ processors, AMD Ryzen™ processors, AMD Athlon™ processors, AMD FX™ processors, Motorola PowerPC, Sun UltraSPARC, Hewlett-Packard PA-RISC processors, Apple-designed processors including Apple A12 processor, Apple A11 processor and others or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system.

A printer system may include the processor 382 connected to one or more memory devices, such as a disk drive, memory, or other device for storing data. Memory is typically used for storing programs, authorized users, etc. during operation of the system. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system. For example, computer control can be implemented to control movement of the extruder 443 and/or print bed, heating of the filament, etc. The processor typically is electrically coupled to a power source which can, for example, be a direct current source, an alternating current source, a battery, a fuel cell or other power sources or combinations of power sources. In a typical configuration, the processor 442 is configured to use 120 Volts or 240 Volts alternating current, though different voltages and direct current can also be used if desired. The power supply 441 can be shared by the other components of the system. The system 440 may also include one or more input devices, for example, a keyboard, mouse, trackball, microphone, touch screen, manual switch (e.g., override switch) and one or more output devices, for example, a printing device, display screen, lights, speaker. As noted herein, the system may contain one or more communication interfaces, e.g. a WiFi antenna. The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces.

In certain embodiments, the system 440 may comprise a storage system. The storage system typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU) or a field programmable gate array (FPGA) or combinations thereof. Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may also be also implemented using specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8 or Windows 10 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system. Further, the processor can be designed as a quantum processor designed to perform one or more functions using one or more qubits. In some instances, a simple set of commands, e.g., G-code or M-code, may be present on the system and used by the processor to move the print head of the system in a desired manner. In certain embodiments, material information, geometric shapes and other information may be present in the storage system to facilitate entry of user parameters into the printing system.

In certain examples, the processor 442 and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C#(C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the system 440 may communicate with a software interface on a mobile device which can couple to an interface of the system 440 to permit a user to transfer user inputs entered into the mobile device to the printer 440. For example, parameters related to part geometry, materials to be used, etc. can be entered on the mobile device and transmitted to the printer system 440. The instructions stored in the memory can execute a software module or control routine for the system, which in effect can provide a controllable model of the printer system.

In certain embodiments, the printer 440 can include one, two or more antennae to permit wireless communication between various components. For example, the antenna may be one or more of a Bluetooth antenna, a cellular antenna, a radio antenna, other antennas or combinations thereof so the printer, or sub-systems thereof, can receive and/or transmit signals.

The extruder 443 of the printing system can include a heating element 451 and a nozzle 452 as shown in FIG. 39. The heating element 451 can receive filament material, heat it and force the melted filament out of the nozzle 452 as the extruder or print bed or both are guided along the generated toolpath(s). The extruded filament is deposited layer by layer to form the printed article. While not shown, the heating element 451 or heater can also include a drive mechanism to force heated/melted filament into the nozzle 453 and out of the extruder. The processor of the system can control the temperature of the heater 451 as desired. Thermistors or other temperature sensing devices can also be present to monitor the temperature of the heating element 451.

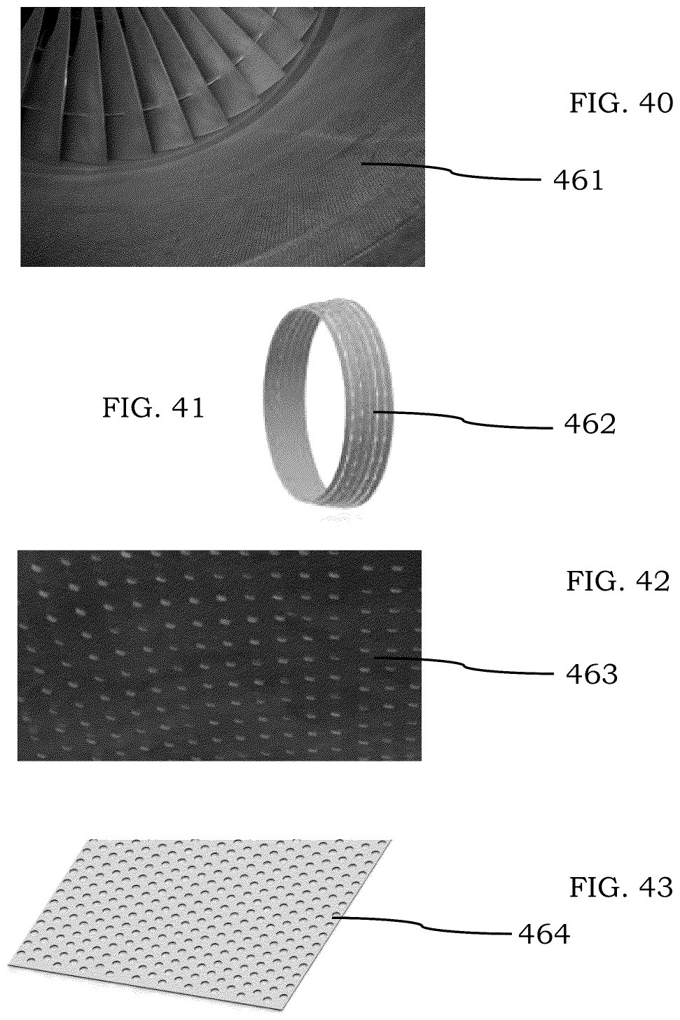

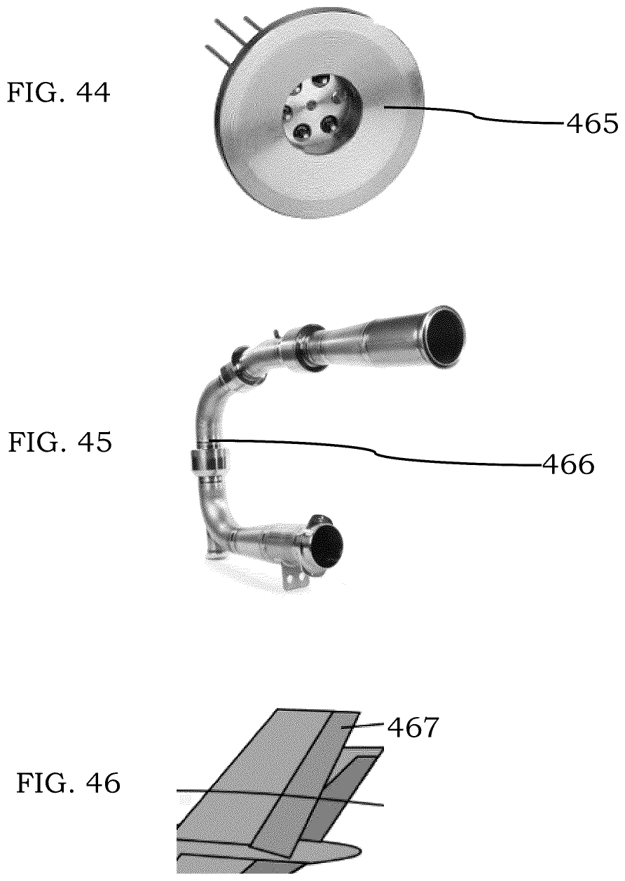

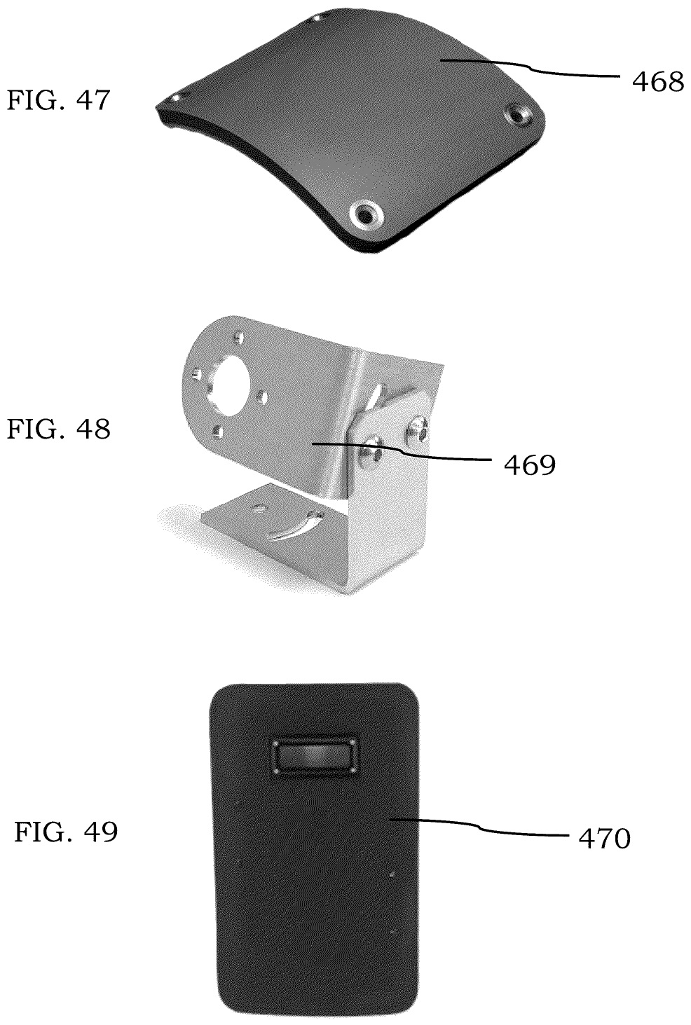

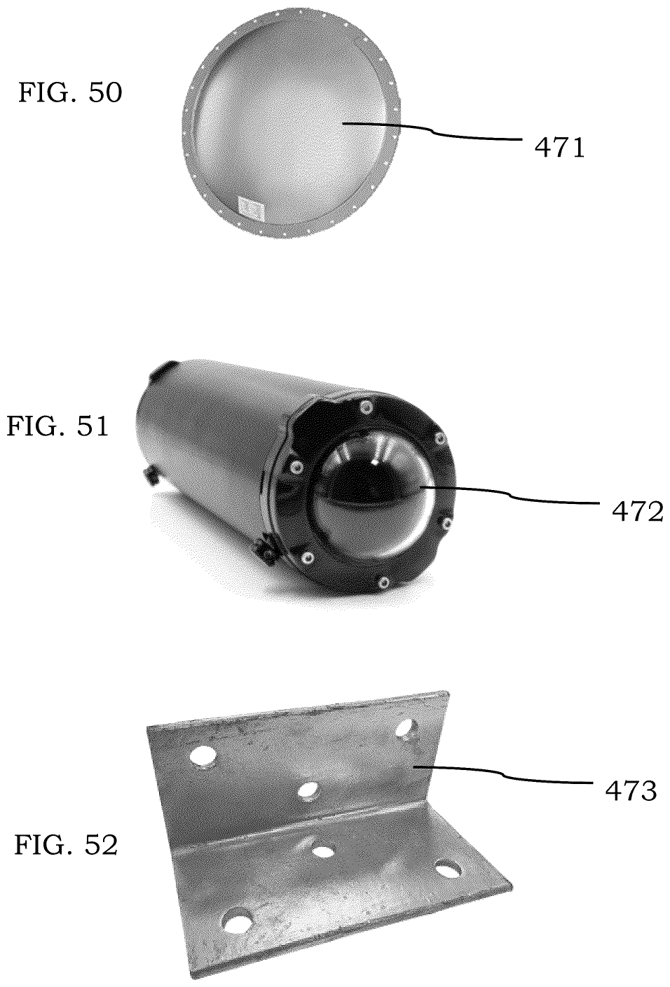

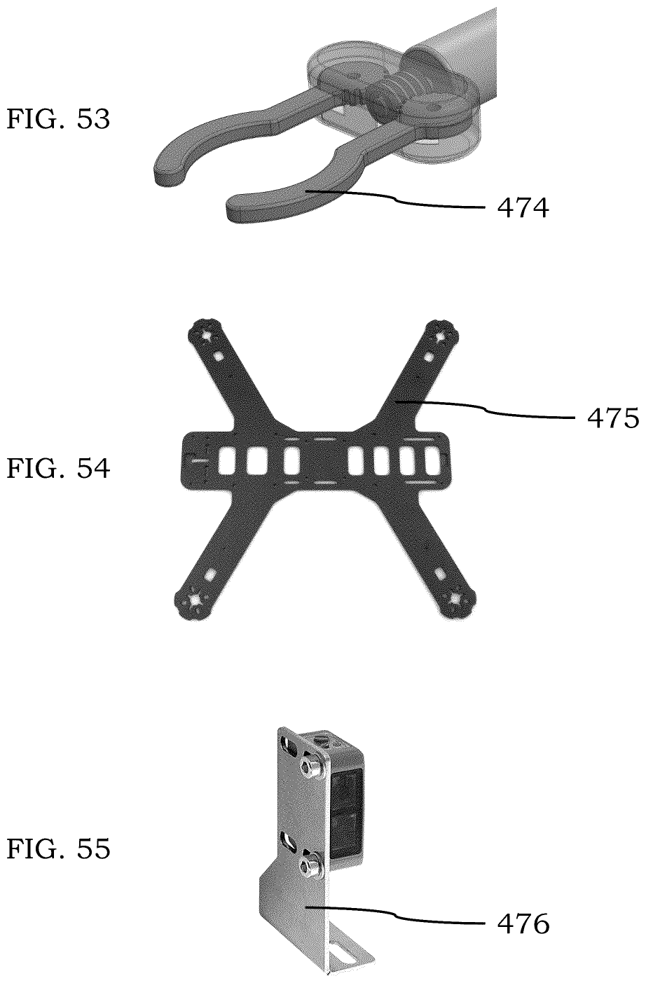

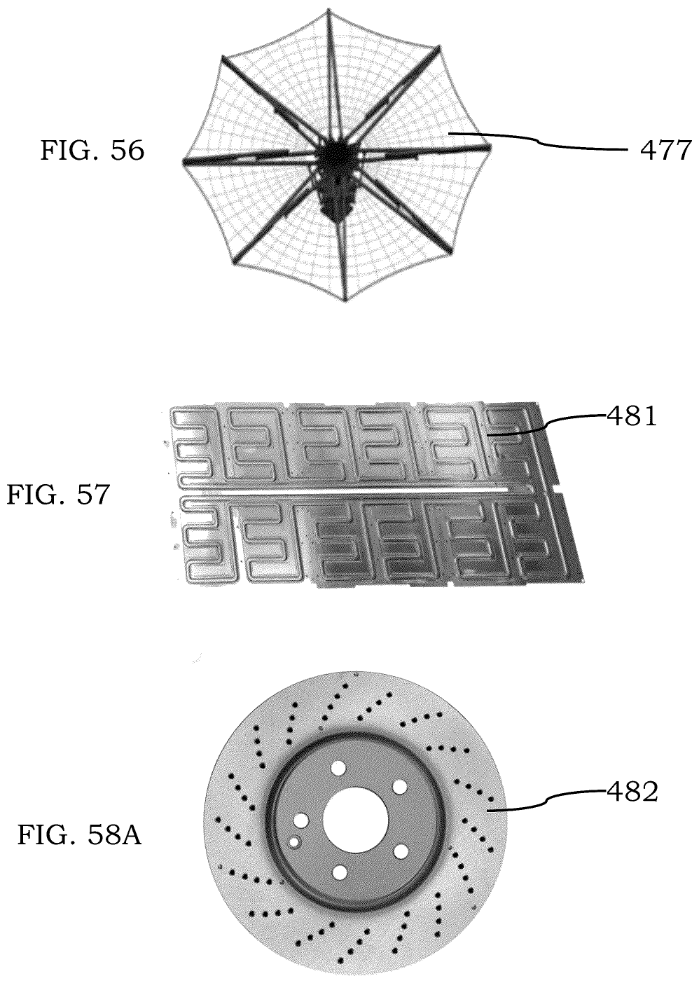

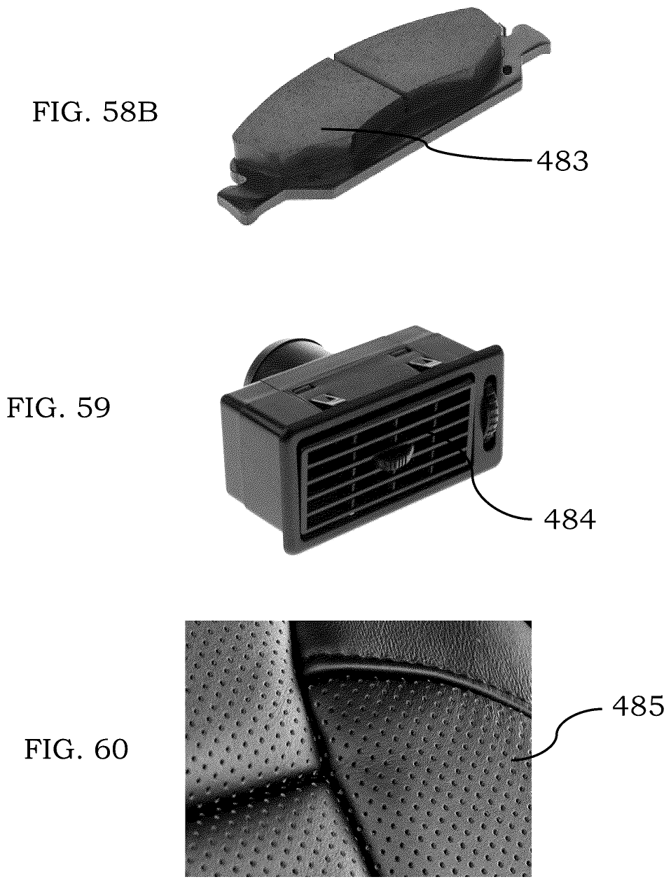

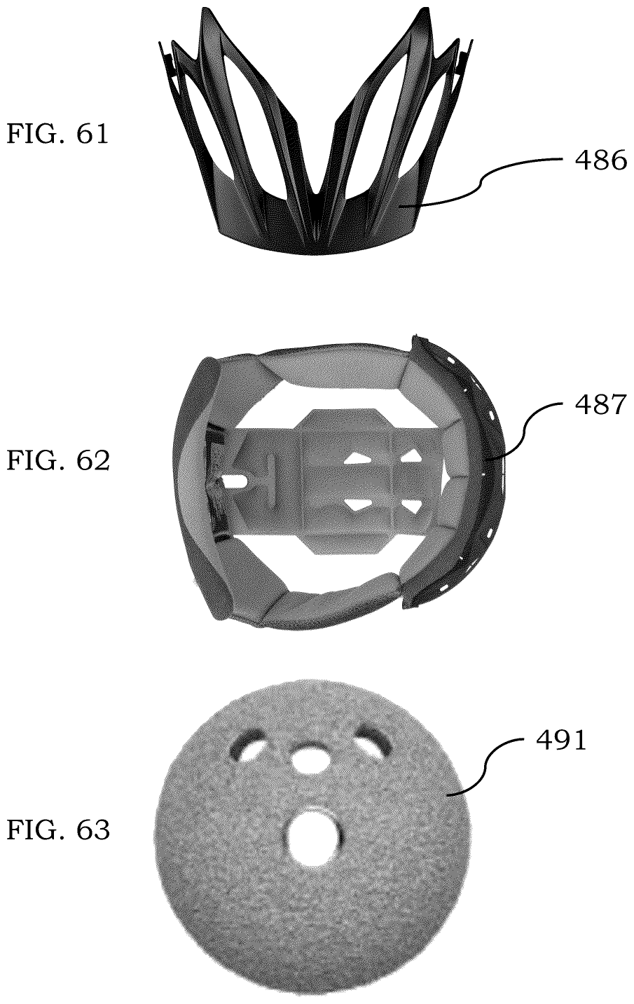

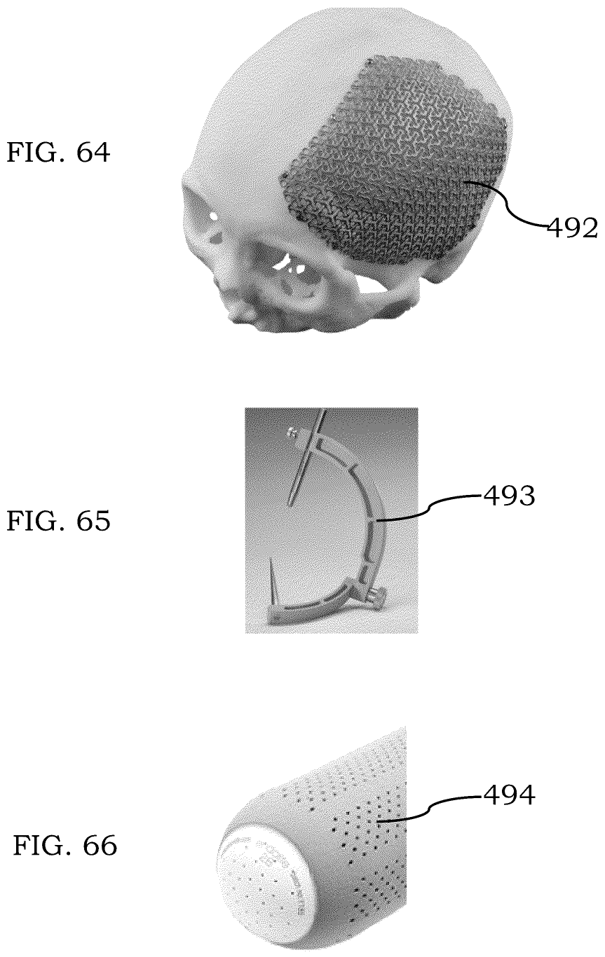

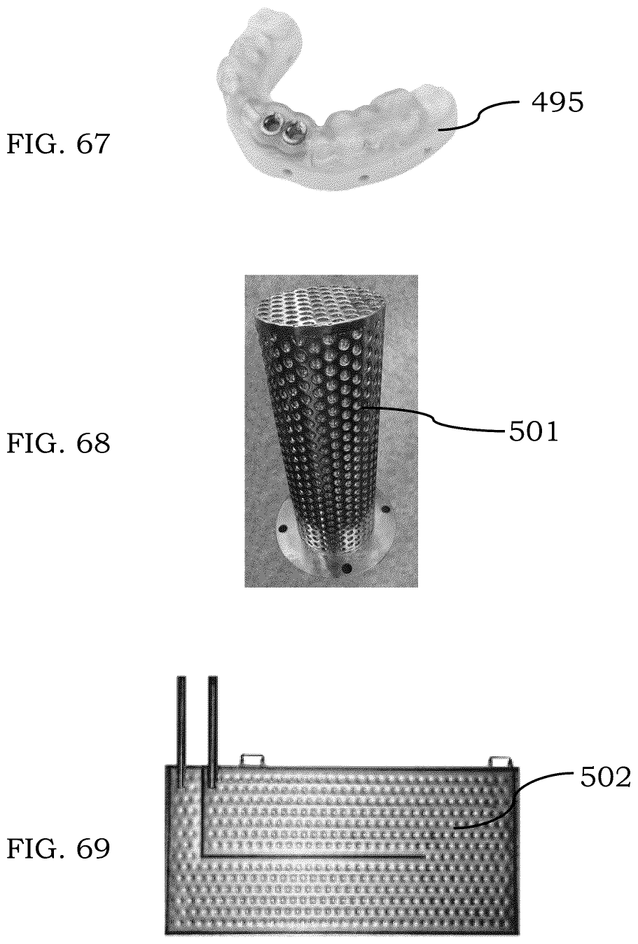

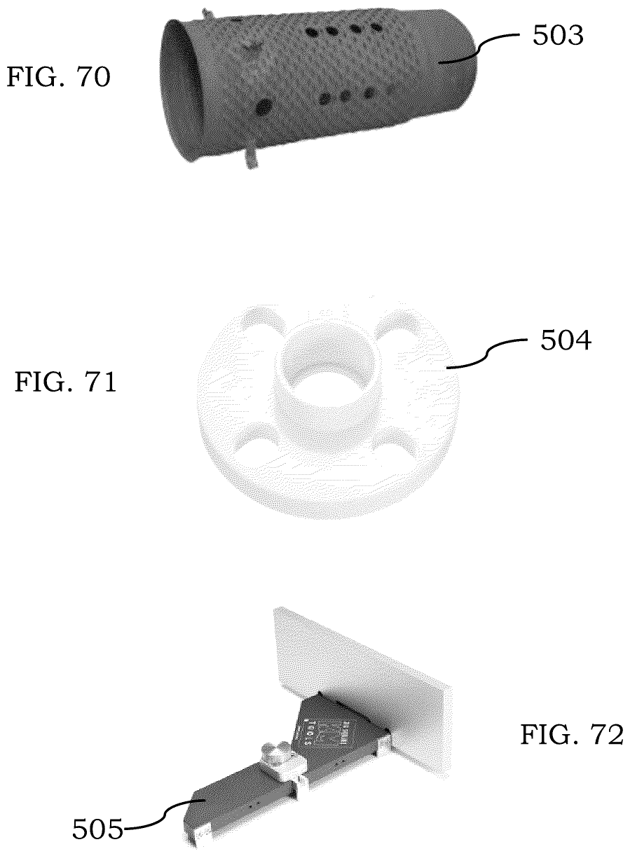

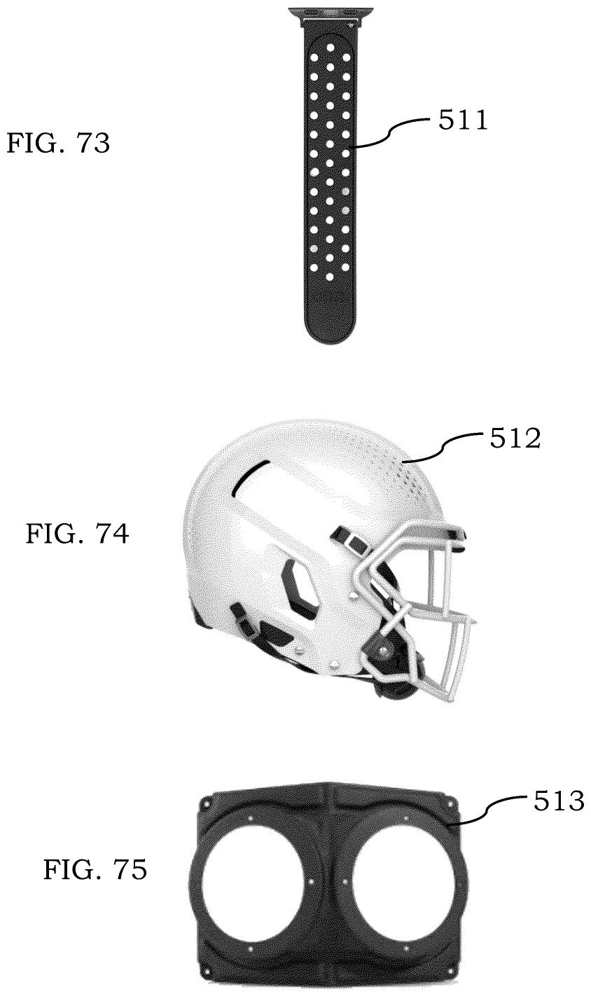

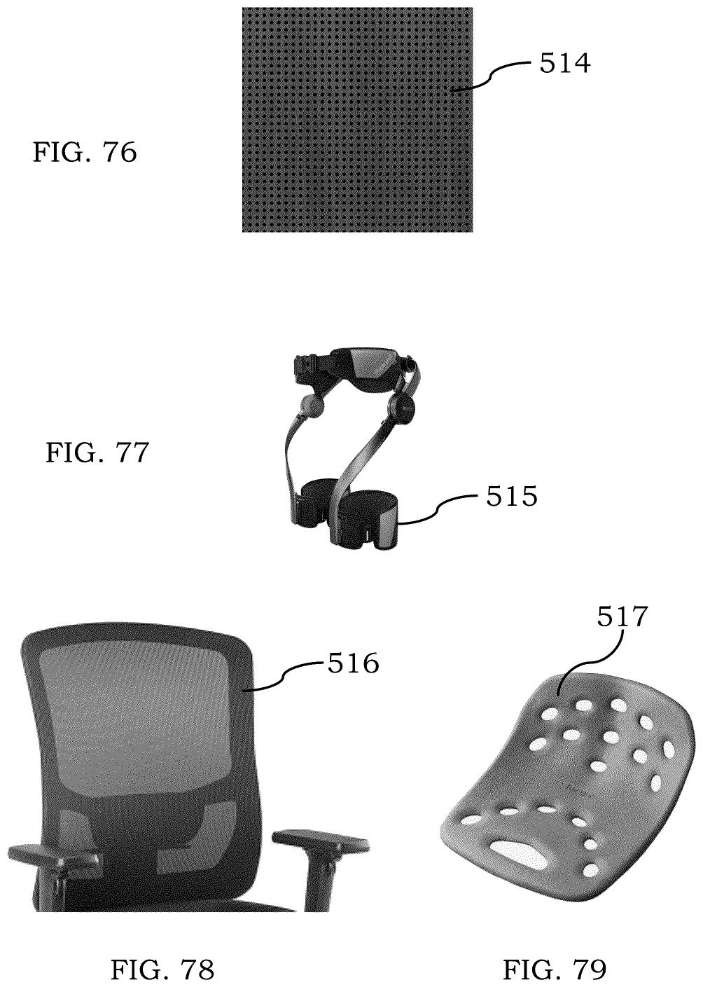

In certain embodiments, the methods and systems described herein can be used to produce printed articles including, but not limited to, acoustic liner panels (e.g., a nacelle liner 461 as shown in FIG. 40), a turbine shroud 462 (FIG. 41), a heat shield 463 (FIG. 42), a high-temp panel 464 with cooling holes on contoured surfaces (FIG. 43), a curved sensor housing 465 (FIG. 44), a bleed air duct 466 with venting holes (FIG. 45), a rudder panel 467 with holes (FIG. 46), a conformal radome 468 (FIG. 47), an infrared sensor mount 469 (FIG. 48), a ballistic shield 470 with holes for ventilation (FIG. 49), a blast panel 471 with dispersal ports (FIG. 50), an underwater acoustic housing 472 (FIG. 51), a structural bracket 473 with mounting holes (FIG. 52), a gripper or end-effector 474 (FIG. 53), a drone body frame 475 (FIG. 54), a sensor integration plate 476 (FIG. 55), or a deployable structure node (FIG. 56). In other instances, the methods and systems described herein can be used to produce printed articles including, but not limited to, a battery cooling plate 481 (FIG. 57), a brake rotor 482 (FIG. 58A) or a brake pad 483 (FIG. 58B), a dashboard air diffuser 484 (FIG. 59), a perforated seating panel 485 (FIG. 60), a helmet visor 486 with airflow channels (FIG. 61) or a helmet liner 487 with airflow channels (FIG. 62). In other embodiments, the methods and systems described herein can be used to produce printed articles including, but not limited to, an orthopedic implant 491 (e.g., an acetabular cup) (FIG. 63), a cranial plate 492 (FIG. 64), a surgical drill guide 493 (FIG. 65), a breathable prosthetic liner 494 (FIG. 66), or a dental implant surgical jig 495 (FIG. 67). In other configurations, the methods and systems described herein can be used to produce printed articles including, but not limited to, a perforated filter plate 501 (FIG. 68), a heat exchanger panel 502 (FIG. 69), a combustion chamber liner 503 (FIG. 70), a flanges/mechanical gasket 504 (FIG. 71), or a tooling fixture or clamping jig 505 (FIG. 72). In some configurations, the methods and systems described herein can be used to produce printed articles including, but not limited to, a smartwatch and fitness band casing 511 (FIG. 73), a sports helmet 512 (FIG. 74), a speaker enclosure 513 (FIG. 75), an acoustic panel 514 (FIG. 76), a wearable exoshell or brace 515 (FIG. 77), an ergonomic chair back 516 (FIG. 78) or a molded cushion 517 (FIG. 79).

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A method for generating reinforcement-aware toolpaths in an additive manufacturing process using a geometric model including mechanical boundary conditions and anisotropic material properties, the method comprising decomposing the received geometric model into a group of individual layers, and, for at least one layer in the decomposed group of individual layers:
generating reinforcement guidelines using a geometry skeleton or simulation-driven design optimization applied to the at least one layer to increase at least one mechanical property of a printed article; and
applying buffering logic to the generated reinforcement guidelines to generate buffered reinforcement zones, wherein the generated buffered reinforcement zones correspond to the reinforcement-aware toolpaths used to print the at least one layer using the additive manufacturing process.

2. The method of claim 1, wherein the geometric model is provided by a user.

3. The method of claim 1, wherein the geometric model is generated using structural simulations.

4. The method of claim 1, wherein the geometric model is decomposed into a plurality of islands, and wherein at least two of the plurality of islands are connected by the geometry skeleton.

5. The method of claim 4, wherein the buffering logic comprises Minkowski-based expansion logic applied to the at least two islands and connected geometry skeleton to generate the buffered reinforcement zones.

6. The method of claim 4, wherein the buffering logic comprises polygonal offsetting.

7. The method of claim 4, wherein the buffering logic comprises Boolean union or Boolean intersection.

8. The method of claim 1, wherein the reinforcement-aware toolpaths are generated across at least two separate layers of the printed article to be deposited, wherein each of the layers is assigned a single load-boundary pair.

9. The method of claim 1, wherein the reinforcement-aware toolpaths are generated by enlarging the reinforced guidelines in a first layer using the buffering logic so the reinforcement-aware toolpath prints additional material in the first layer to increase mechanical strength in the first layer.

10. The method of claim 1, wherein for each group of individual layers, the method comprises generating the reinforcement guidelines using the geometry skeleton or simulation-driven design optimization applied to each of the decomposed group of individual layers to increase at least one mechanical property of the printed article, and applying buffering logic to the generated reinforcement guidelines in each of the decomposed groups to generate buffered reinforcement zones for each of the decomposed groups corresponding to the reinforcement-aware toolpaths used to print that decomposed group, and wherein the method comprises exporting the corresponding reinforcement-aware toolpaths for each group to a printer to print the printed article.

11. An additive manufacturing system configured to print an article using a generated reinforcement-aware toolpath, wherein the additive manufacturing system comprises a processor programmed to decompose a received geometric model into a group of individual layers, and, for at least one layer of the decomposed group of individual layers, the processor is programmed to generate reinforcement guidelines using a geometry skeleton or simulation-driven design optimization applied to the at least one layer to increase at least one mechanical property of the printed article, and apply buffering logic to the generated reinforcement guidelines to generate buffered reinforcement zones, wherein the generated buffered reinforcement zones correspond to the generated reinforcement-aware toolpath used to print the at least one layer.

12. The additive manufacturing system of claim 11, further comprising a motor and an extruder coupled to the motor, wherein the extruder comprises a heater and a nozzle, wherein the heater is configured to melt filament received by the extruder, and wherein the processor is configured to control movement of the extruder to deposit the melted filament along the generated reinforcement-aware toolpath.

13. The additive manufacturing system of claim 12, wherein the processor applies Minkowski-based expansion logic to at least two islands and a connected geometry skeleton to generate the buffered reinforcement zones.

14. The additive manufacturing system of claim 12, wherein the processor applies one or more of polygonal offsetting, Boolean union or Boolean intersection to generated the buffered reinforcement zones.

15. The additive manufacturing system of claim 12, wherein the reinforcement-aware toolpaths are generated across at least two separate layers of the printed article to be deposited, wherein each of the layers is assigned a single load-boundary pair.

16. A non-transitory computer readable medium having instructions stored thereon, wherein the instructions, when executed by a processor, cause the processor to decompose a received geometric model into a group of individual layers, and, for at least one layer of the decomposed group of individual layers, the processor generates reinforcement guidelines using a geometry skeleton or simulation-driven design optimization applied to the at least one layer to increase at least one mechanical property of the printed article, and wherein the processor applies buffering logic to the generated reinforcement guidelines to generate buffered reinforcement zones, wherein the generated buffered reinforcement zones correspond to the generated reinforcement-aware toolpath used to print the at least one layer of the printed article.

17. The non-transitory computer readable medium of claim 16, wherein the instructions, when executed by the processor, cause the processor to control movement of an extruder to deposit melted filament along the generated reinforcement-aware toolpath.

18. The non-transitory computer readable medium of claim 16, wherein the instructions, when executed by the processor, cause the processor to apply Minkowski-based expansion logic to at least two islands and a connected geometry skeleton to generate the buffered reinforcement zones.

19. The non-transitory computer readable medium of claim 16, wherein the instructions, when executed by the processor, cause the processor to apply one or more of polygonal offsetting, Boolean union or Boolean intersection to generated the buffered reinforcement zones.

20. The non-transitory computer readable medium of claim 16, wherein the instructions, when executed by the processor, cause the processor to generate the reinforcement-aware toolpaths across at least two separate layers of the printed article to be deposited, wherein each of the layers is assigned a single load-boundary pair by the processor.

21-55. (canceled)
